(19) United States
(12) Patent Application Publication
(10) Pub. No.: US 2012/0020521 A1
(43) Pub. Date: Jan. 26, 2012

(54) OBJECT POSITION ESTIMATION APPARATUS, OBJECT POSITION ESTIMATION METHOD, AND OBJECT POSITION ESTIMATION PROGRAM

(76) Inventors: Katsuyoshi YAMAGAMI, Osaka (JP); Kenji Kondo, Kyoto (JP); Toru Tanigawa, Kyoto (JP)

(21) Appl. No.: 13/248,380

(22) Filed: Sep. 29, 2011

Related U.S. Application Data
(63) Continuation of application No. PCT/JP2010/007557, filed on Dec. 27, 2010.

(30) Foreign Application Priority Data
Mar. 3, 2010 (JP) 2010-046168

(51) Int. Cl. G06K 9/00

(52) U.S. Cl. 382/103

(57) ABSTRACT

An object-state change determination unit calculates a correspondence relationship between each of a plurality of observed values obtained from a plurality of objects and each of a plurality of the latest object states to be recorded in an object state information storage unit, and determines presence or absence of a change in the object state so that only in a case where there is a change in the object state, an object position is estimated with high precision by using a batch estimation unit, while in the case of no change in the object state, the result of a position estimation of the object with high precision, recorded in the object state information storage unit, is outputted as a result of an object position estimation.

This is a continuation application of International Application No. PCT/JP2010/007557, filed Dec. 27, 2010.

### BACKGROUND OF THE INVENTION

The present invention relates to an object position estimation apparatus for use in estimating positions of a plurality of objects existing in a space to be observed based on observed values relating to corresponding objects sent from an observation device such as a sensor, an object position estimation method, and an object position estimation program.

Systems for estimating a state (for example, a position) of an object based on observed values from a sensor are mainly classified into a sequential (on-line) estimation system and a batch (off-line) estimation system.

The sequential estimation system is a system that sequentially processes observed values that are time-sequentially obtained, and is characterized in that, each time an observed value is obtained, a state estimation value of an object can be obtained at once, and in that computing costs are also inexpensive. However, in contrast, since the estimation is carried out based on only the observed value obtained each time, the system tends to be influenced by an observation error of the sensor or an erroneous observation, and has a problem in that the precision of its estimated value is seriously lowered when a deviated value is obtained as an observed value.

On the other hand, the batch estimation system is a system in which accumulated sensor observed values are batch-processed, and since a series of a plurality of observed values obtained time-sequentially are batch-processed, the resulting characteristic is that, after observed values for a predetermined period of time have been obtained, an estimating process is first carried out. Moreover, although there is a problem in that computing costs are high, the system is also characterized by being hardly susceptible to lowering of estimation precision due to a deviated value that might be caused by an observation error, an erroneous observation, or the like.

As a conventional technique for estimating a state of an object based on observed values of a sensor, a system has been proposed (Patent Document 1) in which both of the characteristics of the sequential estimation system and the batch estimation system are combined with each other.

In Patent Document 1, there are disclosed device and method in which by using the sequential estimation system and batch estimation system combined with each other, an orbit of a satellite is specified based on observed data of positions of the satellite.

More specifically, a basic cycle including three processing steps of 1) estimating a parameter for an equation of motion for regulating an orbit of a satellite by using a batch estimating process, 2) using the parameter for an equation of motion thus estimated as an initial value for a sequential estimating process, and 3) sequentially estimating the position of the satellite by using the sequential estimating process. A prediction error relating to the estimated position of the satellite is directed by the parameter for the equation of motion estimated by the batch estimating process, and this prediction error increases in response to an elapsed period of time from the completion of the batch estimation. By repeating the basic cycle at a timing in which a predetermined threshold value has been exceeded, this system is combined with the characteristic of high-precision estimation of the batch estimation and the characteristic of promptness of the sequential estimation.

### PRIOR ART DOCUMENT

### Patent Document

Patent Document 1: Japanese Unexamined Patent Publication No. 2001-153682

### SUMMARY OF THE INVENTION

### Issues to be Resolved by the Invention

However, the system disclosed in Patent Document 1 is based on the assumption that the position estimation of an object whose position continuously changes in response to an elapsed period of time described by a certain equation of motion is carried out. For this reason, when this system is used for the position estimation of such a semi-stationary object as to repeat a stationary state and a moving state at random, the sequential estimating process is continuously carried out even in a state in which the stationary state is taken for granted. As such a position estimation for a semi-stationary object, for example, an application is considered in which the system is used in a state that is not described by an equation of motion, that is, in a position estimation for such an object as to be carried by a person. In this case, even when position information is obtained with high precision by a batch estimating process, there is a problem in that the precision of the result of the position estimation is lowered by its sequential estimation that is susceptible to an observation error of a sensor and an erroneous observation.

Moreover, the system disclosed by Patent Document 1 is used on the assumption that, with respect to either a single object serving as an observation subject or a plurality of objects serving as the observation subjects, a correspondence relationship between the observed object and the observed value is uniquely determined. The resulting problem is that the system is not applicable to a position estimation of a plurality of objects in which the correspondence relationship between the observed values and the observed objects is indefinite.

The present invention has been devised to resolve the above-mentioned issue, and its objective is to provide an object position estimation apparatus and an object position estimation method as well as an object position estimation program which, even upon position estimation of such a semi-stationary object as to repeat a stationary state and a moving state at random, can highly maintain the precision of an estimated position, and is applicable to a position estimation for a plurality of objects in which the correspondence relationship between the observed value and the object to be observed becomes indefinite.

### Means for Resolving the Issues

In order to resolve the above-mentioned issues, the present invention has the following arrangements:

In accordance with a first aspect of the present invention, there is provided an object position estimation apparatus comprising:

an object-state change determination unit that, each time an observed value including identification information of an object existing in an observation space to be observed and position information of the object is sequentially obtained, determines presence or absence of a state change as to whether or not the object inside the observation space is at least in a stationary state, based on a correspondence relationship between the observed value including the identification information and the position information of the object and object-state information corresponding to a latest estimated value relating to an existing state in the observation space of the object to be observed and a position of the object; and

a batch estimation unit that, when the object-state change determination unit determines that there is a change in the existing state of the object, estimates the identification information and the position information of the object, based on an observed value obtained during a predetermined period of time from time at which the object-state change determination unit has determined that there is the change in the existing state of the object and the existing state of the object determined by the object-state change determination unit.

In accordance with a second aspect of the present invention, there is provided an object position estimation apparatus comprising:

an object-state change determination unit that, each time an observed value including identification information of each of a plurality of objects existing in an observation space to be observed and position information of the object is sequentially obtained, determines presence or absence of a state change as to whether or not each of the objects inside the observation space is at least in a stationary state, based on a correspondence relationship between the observed value including the identification information and the position information of each of the objects and object-state information corresponding to a latest estimated value relating to an existing state in the observation space of the object to be observed and a position of the object; and

a batch estimation unit that, when the object-state change determination unit determines that there is a change in the existing state of the object, estimates the identification information and the position information of the object, based on an observed value obtained during a predetermined period of time from time at which the object-state change determination unit has determined that there is the change in the existing state of the object and the existing state of the object determined by the object-state change determination unit.

In accordance with a fifth aspect of the present invention, there is provided an object position estimation method comprising:

each time an observed value including identification information of each of a plurality of objects existing in an observation space to be observed and position information of the object is sequentially obtained, determining presence or absence of a state change as to whether or not each of the objects inside the observation space is at least in a stationary state, based on a correspondence relationship between the observed value including the identification information and the position information of each of the objects and object-state information corresponding to a latest estimated value relating to an existing state in the observation space of the object to be observed and a position of the object, by using an object-state change determination unit; and

when the object-state change determination unit determines that there is a change in the existing state of the object, estimating the identification information and the position information of the object by using a batch estimation unit, based on an observed value obtained during a predetermined period of time from time at which the object-state change determination unit determines that there is the change in the existing state of the object and the existing state of the object determined by the object-state change determination unit.

In accordance with a sixth aspect of the present invention, there is provided an object position estimation program allowing a computer to execute an object-state change determining means by which, each time an observed value including identification information of each of a plurality of objects existing in an observation space to be observed and position information of the object is sequentially obtained, presence or absence of a state change as to whether or not each of the objects inside the observation space is at least in a stationary state is determined, based on a correspondence relationship between the observed value including the identification information and the position information of each of the objects and object-state information corresponding to a latest estimated value relating to an existing state in the observation space of the object to be observed and a position of the object; and

a batch estimation means by which, when the object-state change determination means determines that there is a change in the existing state of the object, the identification information and the position information of the object are estimated, based on an observed value obtained during a predetermined period of time from time at which the object-state change determination means has determined that there is the change in the existing state of the object and the existing state of the object determined by the object-state change determination means.

### Effects of the Invention

In accordance with the object position estimation apparatus, the object position estimation method, and the object position estimation program of the present invention, it is possible to provide a remarkable effect in that, upon observation of a plurality of semi-stationary articles (for example, such objects as to move and stop repeatedly), after a position of each object has been determined with high precision by using a batch estimating process based on an observed value acquired from a point of time at which the object-state change determination means has determined that there is a change in the object state from a moving state to a stationary state, and an existing state of the object determined by the object-state change determination means, and during a stationary state of the article, the position information with high precision obtained by the batch estimation can be outputted as estimated information. In other words, the present invention is free from the prior art problem in that a positional error occurs due to a position estimation that is carried out by a sequential estimating process even on an object whose stationary state is taken for granted.

Moreover, in accordance with the object position estimation apparatus, the object position estimation method, and the object position estimation program of the present invention, it is possible to also obtain another effect in which, by determining a state change from a stationary state to a moving state of an object to be observed, or from a moving state to a stationary state thereof, by using the object-state change determination means, a stationary state of the object or a moving state thereof at an arbitrary point of time during observation can be confirmed with respect to all the objects.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a block diagram showing an example of a structure of a first aspect of the present invention;

FIG. 2A is a block diagram showing an example of a structure of an object position estimation apparatus in accordance with a first embodiment of the present invention;

FIG. 2B is a block diagram showing a structure of an object image recognition sensor that is one example of an observing device of the object position estimation apparatus in accordance with the first embodiment;

FIG. 3 is a view showing an example of a room in which the object position estimation apparatus of the first embodiment of the present invention is installed;

FIG. 4 is a view showing an article that is one example of an object to be observed in an object position estimating process in the object position estimation apparatus of the first embodiment of the present invention;

FIG. 5 is a view showing one example of information recorded in an observed value accumulation table of the object position estimation apparatus in accordance with the first embodiment of the present invention;

FIG. 6 is a view showing one example of information recorded in an article-state change information table of the object position estimation apparatus in accordance with the first embodiment of the present invention;

FIG. 7 is a view showing one example of information recorded in an article-position estimated value table of the object position estimation apparatus in accordance with the first embodiment of the present invention;

FIG. 8 is a view showing a display example of a screen of an article position display unit of the object position estimation apparatus in accordance with the first embodiment of the present invention;

FIG. 9 is a flow chart showing operations of the object position estimation apparatus in accordance with the first embodiment of the present invention;

FIG. 10 is a flow chart showing a determining process (step S200) of an article existing state change in the object position estimating process in the object position estimation apparatus in accordance with the first embodiment of the present invention;

FIG. 11 is a flow chart showing a batch estimating process (step S500) of the object position estimating process in the object position estimation apparatus in accordance with the first embodiment of the present invention;

FIG. 12 is a flow chart showing operations of the article position display unit of the object position estimation apparatus in accordance with the first embodiment of the present invention;

FIG. 13 is a view showing one portion of information recorded on the observed value accumulation table of the object position estimation apparatus in accordance with the first embodiment of the present invention;

FIG. 14 is a timing chart showing a time-based change in the article existing state of the object position estimating process in the object position estimation apparatus and a change in the operation sequence of the object position estimation apparatus in accordance with the first embodiment of the present invention;

FIG. 15 is a view showing an example of calculations of a likelihood for use in determining an article existing state change in the object position estimating process in the object position estimation apparatus in accordance with the first embodiment of the present invention;

FIG. 16 is a view showing another example of calculations of the likelihood for use in determining an article existing state change in the object position estimating process in the object position estimation apparatus in accordance with the first embodiment of the present invention;

FIG. 17 is a view showing still another example of calculations of the likelihood for use in determining an article existing state change in the object position estimating process in the object position estimation apparatus in accordance with the first embodiment of the present invention;

FIG. 18 is a view showing one example of information that is recorded in the article-state change information table of the object position estimation apparatus in accordance with the first embodiment of the present invention;

FIG. 19 is a view showing one example of information that is recorded in the article-position estimated value table of the object position estimation apparatus in accordance with the first embodiment of the present invention;

FIG. 20 is a view showing still another example of calculations of the likelihood for use in determining an article existing state change in the object position estimating process in the object position estimation apparatus in accordance with the first embodiment of the present invention;

FIG. 21 is a view showing the other example of calculations of the likelihood for use in determining an article existing state change in accordance with the first embodiment of the present invention;

FIG. 22A is a view showing an example in which a change in an article existing state of an object position estimating process is displayed on an article position display unit in the object position estimation apparatus in accordance with the first embodiment of the present invention;

FIG. 22B is a view showing another example in which a change in the article existing state of the object position estimating process in the object position estimation apparatus in accordance with the first embodiment of the present invention is displayed on the article position display unit;

FIG. 22C is a view showing still another example in which a change in the article existing state of the object position estimating process in the object position estimation apparatus in accordance with the first embodiment of the present invention is displayed on the article position display unit;

FIG. 22D is a view showing a still another example in which a change in the article existing state of the object position estimating process in the object position estimation apparatus in accordance with the first embodiment of the present invention is displayed on the article position display unit;

FIG. 22E is a view showing still another example in which a change in the article existing state of the object position estimating process in the object position estimation apparatus in accordance with the first embodiment of the present invention is displayed on the article position display unit; and

FIG. 22F is a view showing the other example in which a change in the article existing state of the object position estimating process in the object position estimation apparatus in accordance With the first embodiment of the present invention is displayed on the article position display unit.

### DETAILED DESCRIPTION OF THE EMBODIMENTS

Referring to drawings, the following description will refer to embodiments of the present invention in detail.

Prior to the detailed description of the embodiments of the present invention with reference to the drawings, the following will describe various aspects of the present invention.

In accordance with a first aspect of the present invention, there is provided an object position estimation apparatus comprising:

an object-state change determination unit that, each time an observed value including identification information of an object existing in an observation space to be observed and position information of the object is sequentially obtained, determines presence or absence of a state change as to whether or not the object inside the observation space is at least in a stationary state, based on a correspondence relationship between the observed value including the identification information and the position information of the object and object-state information corresponding to a latest estimated value relating to an existing state in the observation space of the object to be observed and a position of the object; and

a batch estimation unit that, when the object-state change determination unit determines that there is a change in the existing state of the object, estimates the identification information and the position information of the object, based on an observed value obtained during a predetermined period of time from time at which the object-state change determination unit has determined that there is the change in the existing state of the object and the existing state of the object determined by the object-state change determination unit.

In accordance with a second aspect of the present invention, there is provided an object position estimation apparatus comprising:

an object-state change determination unit that, each time an observed value including identification information of each of a plurality of objects existing in an observation space to be observed and position information of the object is sequentially obtained, determines presence or absence of a state change as to whether or not each of the objects inside the observation space is at least in a stationary state, based on a correspondence relationship between the observed value including the identification information and the position information of each of the objects and object-state information corresponding to a latest estimated value relating to an existing state in the observation space of the object to be observed and a position of the object; and

a batch estimation unit that, when the object-state change determination unit determines that there is a change in the existing state of the object, estimates the identification information and the position information of the object, based on an observed value obtained during a predetermined period of time from time at which the object-state change determination unit has determined that there is the change in the existing state of the object and the existing state of the object determined by the object-state change determination unit.

In accordance with a third aspect of the present invention, there is provided an object position estimation apparatus described in the first aspect or the second aspect, wherein, when the object-state change determination unit determines that there is a change in the object to be observed from the stationary state to a moving state, and then during a period until determination that the moving state has been changed to the stationary state is made, the batch estimation unit neither carries out any estimating process on the identification information and the position information of the object, nor outputs the estimated value.

In accordance with a fourth aspect of the present invention, there is provided an object position estimation apparatus described in the first aspect or the second aspect, wherein, when the object-state change determination unit determines that there is a change in the object to be observed from a moving state to the stationary state, and then during a period until determination that the stationary state has been changed to the moving state is made, the batch estimation unit carries out an estimating process only once on the identification information and the position information of the object when determined that there is a change in the object into the stationary state, and then outputs the estimated value obtained by the estimating process as object state information of the object.

In accordance with a fifth aspect of the present invention, there is provided an object position estimation method comprising:

each time an observed value including identification information of each of a plurality of objects existing in an observation space to be observed and position information of the object is sequentially obtained, determining presence or absence of a state change as to whether or not each of the objects inside the observation space is at least in a stationary state, based on a correspondence relationship between the observed value including the identification information and the position information of each of the objects and object-state information corresponding to a latest estimated value relating to an existing state in the observation space of the object to be observed and a position of the object, by using an object-state change determination unit; and

when the object-state change determination unit determines that there is a change in the existing state of the object, estimating the identification information and the position information of the object by using a batch estimation unit, based on an observed value obtained during a predetermined period of time from time at which the object-state change determination unit determines that there is the change in the existing state of the object and the existing state of the object determined by the object-state change determination unit.

In accordance with a sixth aspect of the present invention, there is provided an object position estimation program allowing a computer to execute an object-state change determining means by which, each time an observed value including identification information of each of a plurality of objects existing in an observation space to be observed and position information of the object is sequentially obtained, presence or absence of a state change as to whether or not each of the objects inside the observation space is at least in a stationary state is determined, based on a correspondence relationship between the observed value including the identification information and the position information of each of the objects and object-state information corresponding to a latest estimated value relating to an existing state in the observation space of the object to be observed and a position of the object; and

a batch estimation means by which, when the object-state change determination means determines that there is a change in the existing state of the object, the identification information and the position information of the object are estimated, based on an observed value obtained during a predetermined period of time from time at which the object-state change determination means has determined that there is the change in the existing state of the object and the existing state of the object determined by the object-state change determination means.

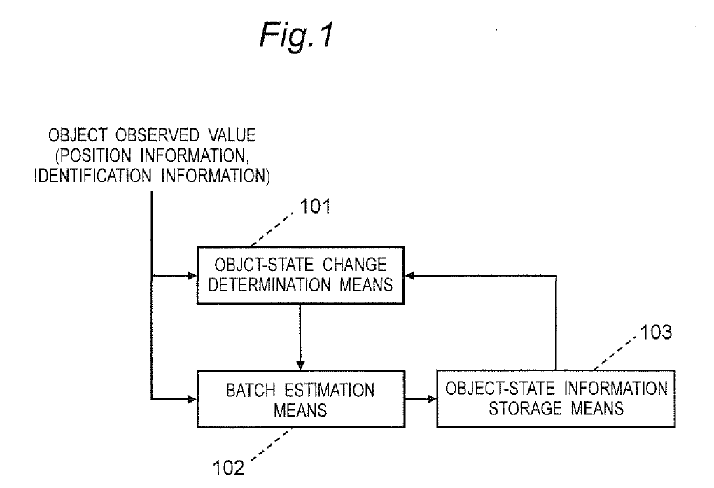

FIG. 1 is a block diagram showing one example of a structure of the object position estimation apparatus in accordance with the first aspect of the present invention. The object position estimation apparatus of the first aspect is provided with object-state change determination means (object-state change determination unit) 101 to which an object observed value (position information and identification information of an object) is inputted and batch estimation means (batch estimation unit) 102 to which the object observed value (position information and identification information of the object) and the output information from the object-state change determination means 101 are inputted. In this structure, object state information storage means (object state information storage unit) 103 to which the output information from the batch estimation means 102 is inputted and from which the corresponding information is outputted to the object-state change determination means 101 may be further installed.

With this arrangement, the object-state change determination means 101 calculates a correspondence relationship between respective observed values obtained from a plurality of objects in an observation space serving as examples of observed values including identification information of each of objects existing in the observation space to be observed and position information of the object, and the object state of each of the objects to be estimated in the object position estimation apparatus, for example, the latest object state of each of the objects. In a case where, as a result of calculations, an observed value that determines that there is a change in the existing state of the corresponding object, for example, an observed value that determines that the corresponding object state is not present, is found, it is determined that an object has newly appeared (or has been brought into an observable state) in the observation space. In contrast, in a case where there is an object state that is determined as no corresponding observed value being present, it is determined that an object has disappeared (or has been brought into an unobservable state) in the observation space.

Thus, based on the observed value acquired when the object-state change determination means 101 determines that there is a change in the existing state of an object in the observation space (for example, a plurality of observed values obtained in a fixed period (a predetermined number of times) from a timing at which the object-state change determination means 101 has determined that there is a change in the existing state of an object inside the observation space) and the existing state of the object determined by the object-state change determination means, a batch estimating process is carried out by the batch estimation means 102 so that the position estimation relating to each of the objects can be carried out with high precision, with the correspondence relationship between the observed values and the objects being taken into consideration.

Moreover, while the object-state change determination means 101 determines that no change in the existing state of an object is found, the estimated position, estimated with high precision by this batch estimating process, can be held in the object state information storage means 103, and continuously maintained as the latest object position information so that it is possible to avoid an observation error in the observing device or a deterioration in estimating position precision due to an influence from an observation error, in a positional estimating process for a semi-stationary object, such as an object that repeatedly stops and moves at random, which poses a problem in the sequential estimation.

Referring to the drawings, the following will describe embodiments of the present invention.

### First Embodiment

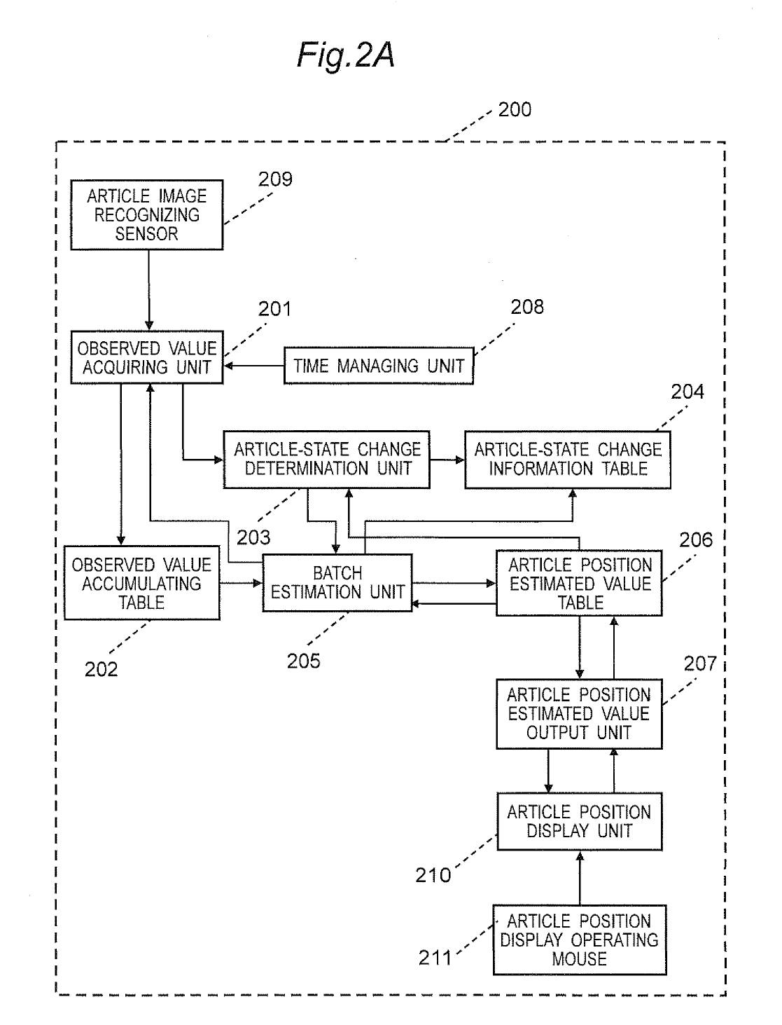

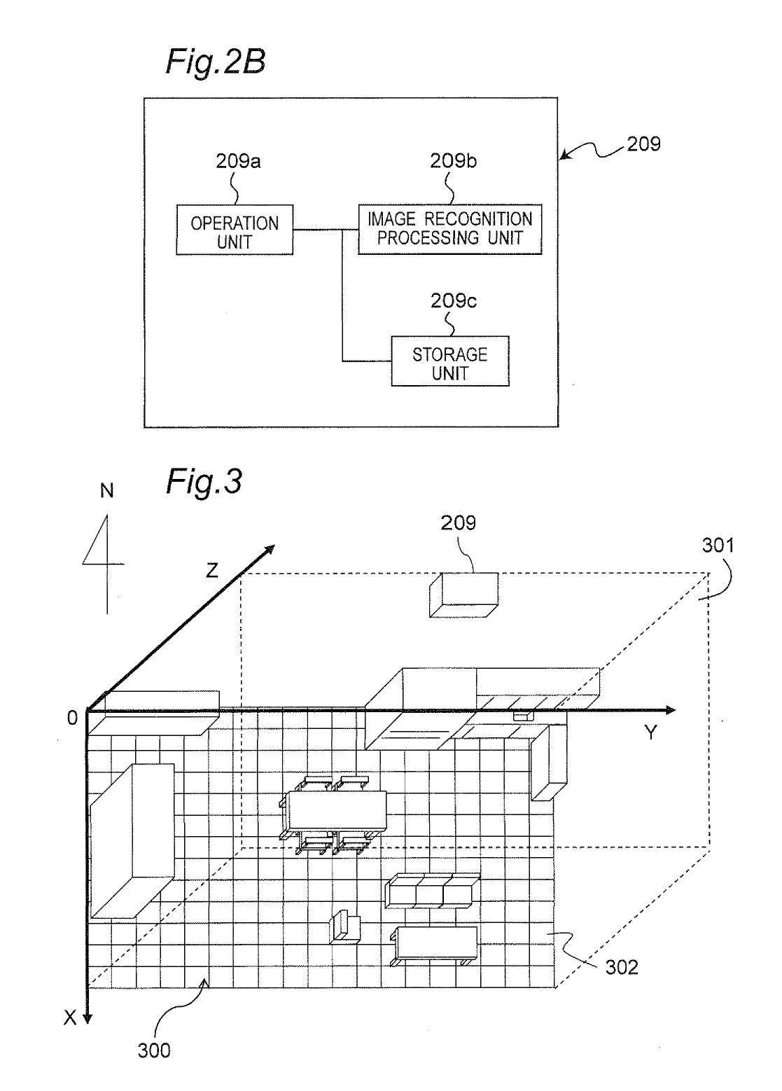

An object position estimation apparatus 200 in accordance with the first embodiment of the present invention allows an article-image recognizing sensor 209 serving as one example of an observing device to pick up an image inside a room such as a life space, as one example of an observation space, from its ceiling, and carries out a position detecting process and an article identifying process of an article serving as one example of an object through an image recognizing process so that based on observed information including the position information and the identification information, a change in an existing state of the article is determined to estimate the position of the article. In the present embodiment, a camera is used as one example of the article-image recognizing sensor 209. As shown in FIG. 2B, the article-image recognizing sensor 209 is provided with an image-pickup unit 209a, an image recognition processing unit 209b for carrying out an image recognizing treatment on the image picked up by the image-pickup unit 209a, and a storage unit 209c that stores an image picked up by the image-pickup unit 209a, information resulting from the treatment by the image recognition processing unit 209b, and the like.

FIG. 2A is a block diagram showing a structure of the object position estimation apparatus 200 in accordance with the first embodiment of the present invention. The object position estimation apparatus 200 is provided with an observed value acquiring unit 201, an observed value accumulating table (observed value storage unit) 202, an article-state change determination unit (article-state change determination means) 203 serving as one example of the object-state change determination means 101 of FIG. 1, an article-state change information table (article-state change information storage unit) 204 serving as one example of the object-state information storage means 103 of FIG. 1, a batch estimation unit (batch estimation means) 205 serving as one example of the batch estimation means 102 of FIG. 1, an article-position estimated value table (article position estimated value storage unit) 206 serving as one example of the object-state information storage means 103 of FIG. 1, an article position estimated value output unit 207, a time managing unit 208, an article-image recognizing sensor 209, an article position display (article position display unit) 210, and an object position display-operating mouse (article position display operation unit) 211.

FIG. 3 shows an example in which the article-image recognizing sensor 209 of the object position estimation apparatus 200 of the first embodiment of the present invention is installed in a room 300 as one example of the observation space. As shown in FIG. 3, the article-image recognizing sensor 209 is attached to a ceiling 301 of the room 300. In this case, as shown in FIG. 3, a coordinate system on which positions in this room 300 are plotted has the north west corner of a floor surface 302 of the room 300 determined as the origin, and is prepared as an orthogonal coordinate system with its X axis being set in the south direction of the floor surface 302, its Y axis being set in the south direction of the floor surface 302, and its Z axis being set in the vertical direction of the floor surface 302. In the following description, this coordinate system is referred to as a world coordinate system of the room 300, or to simply as a world coordinate system.

As shown in FIG. 2B, the article-image recognizing sensor 209 is designed to be provided with a camera unit (image pickup unit) 209a that picks up an image of the room 300, and outputs picked-up image data that are two-dimensional arrays of luminance values every time the image is picked up, an image recognizing unit 209b that carries out an image recognizing process on the picked-up image data outputted from the camera unit 209a, and an inner storage unit 209c that stores images picked up by the camera unit 209a, and information corresponding to the processed results by the image recognition processing unit 209b, or the like. The camera unit 209a is supposed to have a viewing angle capable of picking up the image of the entire room 300.

In this case, the number of the cameras forming the camera unit 209a possessed by the article-image recognizing sensor 209 is set to one; however, a plurality of cameras may be prepared. For example, a plurality of cameras, each having a small viewing angle, may be used to pick up the image of the entire room 300. Moreover, image pick-up ranges of cameras may be overlapped with one another so that images of the same range can be picked up from a plurality of directions.

The image recognizing unit 209b extracts an article area image from the picked-up image data outputted by the camera unit 209a by using a background differential method, and first specifies the position of the article. For example, as shown in FIG. 26, comparisons by the image processing unit 209c are made between background image data of the room 300 with no articles being present therein, that have been preliminarily picked up by the camera unit 209a and stored in the inner storage unit 209b, and the present image data picked up by the camera unit 209a. Thereafter, an area having different pixel values is taken out as a differential area by the image processing unit 209c. This differential area corresponds to a detected article. Moreover, the article area images thus extracted are collated with template images preliminarily prepared for every article to be identified, by the image processing unit 209c, so that the kinds of the articles are identified in the image processing unit 209c. The template images for use in the collation are supposed to be preliminarily recorded in the inner storage unit 209c. Additionally, with respect to the image recognizing process for identifying or position-specifying articles, another method may be used. For example, an article identifying algorithm by the use of SIFT amount of characteristics may be used.

An observed value outputted from the article-image recognizing sensor 209 corresponds to data formed by combining the observed position of the recognized article with an observation ID likelihood representing a certainty as to which article the observed article is defined as, with respect to article ID's preliminarily assigned to each of the kinds of articles.

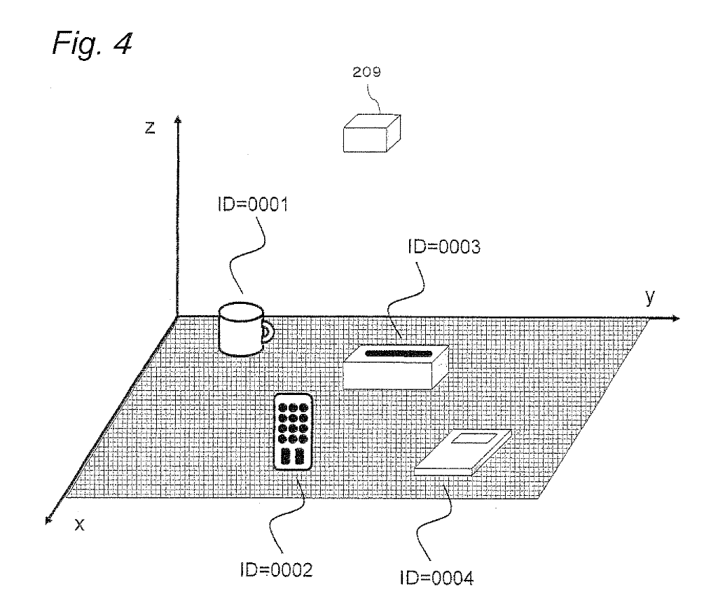

One example of the above-mentioned article ID is shown below. For example, as shown in FIG. 4, in a case where articles to be observed are four items, that is, a cup, a remote controlling device (remote controller), a tissue paper box, and a magazine, it is supposed that article ID 0001 is assigned to the cup, article ID 0002 is assigned to the remote controller, article ID 0003 is assigned to the tissue paper box, and article ID 0004 is assigned to the magazine. As to which ID is specifically assigned to which article (identifiers from 0001 to 0004 in the example of FIG. 4), it is desirably determined.

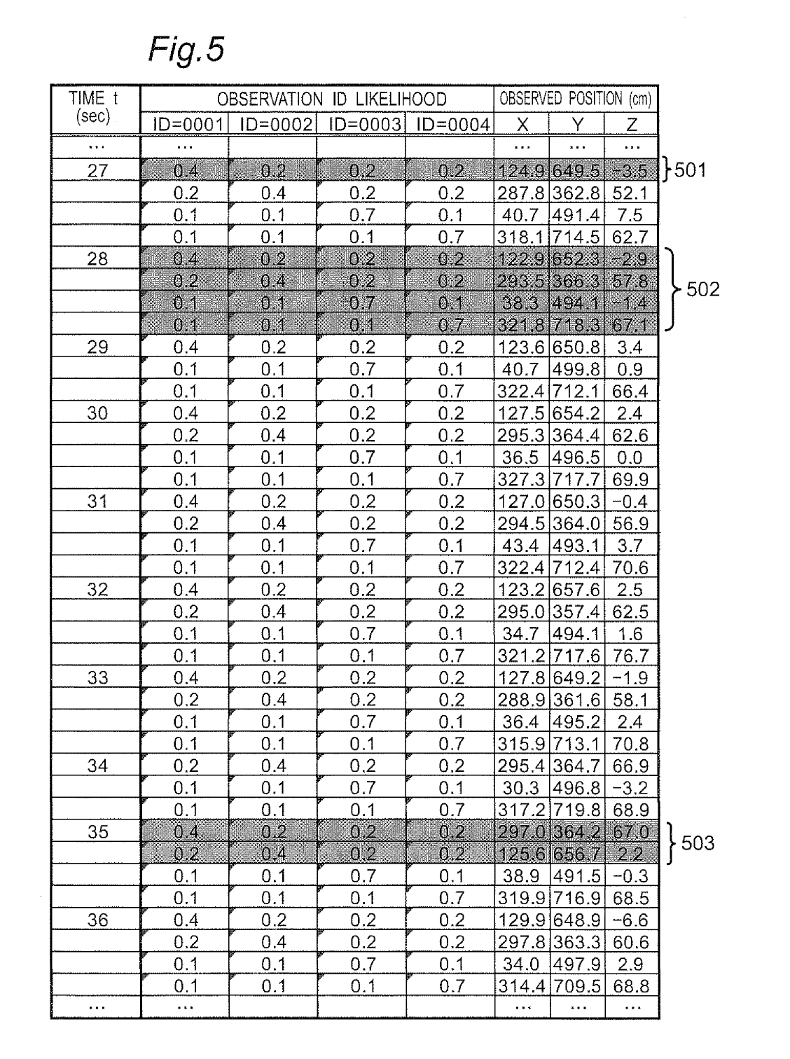

FIG. 5 exemplifies the contents to be recorded on the observed value accumulating table 202, which will be explained later, and in FIG. 5, examples of observed values to be outputted from the article-image recognizing sensor 209 are shown. For example, observation time (time at which the observed value is acquired) t, an observation ID likelihood, and an observed position (values of XYZ coordinates) are stored as examples of the observed values. Data indicated in an area 501 (a portion with a gray background) of FIG. 5 correspond to observed values relating to one article (observed values including an observation ID likelihood and an observed position at observation time t=27 seconds). Numeric values in four frames from the second to the fifth from the left (with article ID of 0001, article ID of 0002, article ID of 0003, and article ID of 0004) represent observation ID likelihoods, and numeric values in the third frame from the right (a value of X coordinate, a value of Y coordinate, and a value of Z coordinate in the observed position) represent the observed position in the world coordinate system. The observed position indicated by these observed values is a position obtained by converting a position in the image coordinate system of image data picked up by the article-image recognizing sensor 209 into a corresponding position in the world coordinate system.

Additionally, in the present first embodiment, an image sensor provided with an image recognizing function is used as the article-image recognizing sensor 209 for observing articles inside the room 300; however, a sensor other than the image sensor may be used as long as it can identify the positions and kinds of the articles to be observed. For example, as another example of the article-image recognizing sensor 209, an RFID, or a laser range sensor, or the like, or a combination of a plurality of kinds of sensors may be used.

The observed value acquiring unit 201 of FIG. 2A successively acquires an observed value from the article-image recognizing sensor 209 every fixed period of time, refers to the current time held in the time managing unit 208, and adds the time at which the observed value is acquired and the observed value to the observed value accumulating table 202 to be recorded therein. Additionally, in the first embodiment, the observed value acquiring unit 201 is supposed to acquire the observed value in a predetermined cycle, for example, every one second.

The observed values acquired by the observation value acquiring unit 201 at once are a plurality of observed values corresponding to a plurality of articles that were observed. In FIG. 5, observed values in an area with a gray background within a region 502 are a plurality of observed values (four observed values in FIG. 5) acquired at time t=28 seconds. Each of the observed value includes a pair of an observation ID likelihood and an observed position as the results of the observation.

Simultaneously as the observation value acquiring unit 201 records the observed values in the observed value accumulating table 202, the observation value acquiring unit 201 outputs the values to the article-state change determination unit 203.

The observed value accumulating table 202 accumulates the observed values acquired by the observation value acquiring unit 201 together with the observed time. FIG. 5 shows observed values acquired for a period of time t=27 to 36 seconds among the observed values accumulated therein.

FIG. 5 shows observed values resulting from the observations of four articles ID's=0001 to 0004 whose world coordinates at true positions correspond to (125, 654, 0), (296, 362, 60), (38, 496, 0), and (321, 715, 70) respectively. The unit of time is second, and the unit of position is centimeter. In FIG. 5, at time t=29 seconds as well as at time t 34 seconds, observed values corresponding to the number of articles (four articles in this case) are not obtained, and this indicates that in the article-image recognizing sensor 209, lacking of the observed value, such as a failure in extracting an article image, sometimes occurs.

Moreover, in the article-image recognizing sensor 209, since an article is recognized through an image recognition, there is a possibility of an identifying error of the article. The possibility of this error is quantitatively represented by a numeric value, referred to as “observation ID likelihood”. The meaning of “the observation ID likelihood” corresponds to a distribution of certainty for each of article ID's relating to the identified results of articles by the article-image recognizing sensor 209. In other words, “the observation ID likelihood” means a probability distribution as to which article each observed value is derived from.

The four observed values in the region 502 of FIG. 5 are observed values resulting from the observations of article ID=0001, article ID=0002, article ID=0003, and article ID=0004 successively in this order from the above.

The first observed value in the region 502 from the above has an observation ID likelihood value of 0.4 relative to article ID 0001, which is the highest value, and the observation ID likelihood of the other articles is 0.2. The observed value has a probability of 0.4 of being an observed value from the observation of article ID=0001, and also has a probability of 0.2 of being an observed value from the observation of an article other than the article with article ID=0001.

The observed value on the third line from the above of the region 502 has an observation ID likelihood value of 0.7 relative to article ID=0003, which is the highest value, and the observation ID likelihood of the other articles is 0.1. The observed value has a probability of 0.7 of being an observed value from the observation of article ID=0003, and also has a probability of 0.1 of being an observed value from the observation of an article other than the article with article ID=0003.

In the region 502, the third observed value has a probability (0.7) of being derived from the observation of article ID=0003, which is higher than a probability of (0.4) of the first observed value of being derived from the observation of article ID=0003, and from the viewpoint of reliability of article identification, the third observed value has higher reliability than that of the first observed value.

The state of an erroneous recognition of an article changes depending on image characteristics of the respective articles to be identified, or a difference in image characteristics between the articles, or illuminating conditions of the space in which the articles are observed, or states of occlusion (a state in which an object on the rear side is hardly recognizable because of an object positioned on the front side), or the like. For this reason, ideally, each time an observation is carried out, an observation. ID likelihood in which a probability of an erroneous recognition has been reflected should be calculated by taking its observation conditions into consideration; however, for this purpose, all the observation conditions need to be preliminarily evaluated, and actually, such operations cannot be executed.

In practice, identifying experiments of an object are carried out under certain fixed (or a plurality of limited) observation conditions, and an observation ID likelihood is preliminarily obtained for each of the articles based on the correction rate of article identification, and upon actually carrying out a position estimation on an article, an approximation process is carried out by assigning the observation ID likelihood that has been thus obtained. In the present first embodiment also, the observation ID likelihood to be outputted from the article-image recognizing sensor 209 is supposed to be preliminarily obtained through experiments.

Moreover, when two observed values shown in a region 503 are taken into consideration, the distribution of the observation ID likelihood shows that the first observed value in the region 503 has the highest probability of being derived from the observation of article ID=0001, and that the second observed value in the region 503 has the highest probability of being derived from the observation of article ID=0002.

However, when the error range of the observed position relative to the true position of an article is taken into consideration, it is understood that the first observed value is actually derived from the observation of article ID=0002, and the second observed value is derived from the observation of article ID=0001.

In other words, the region 503 of FIG. 5 indicates a state in which article ID=0001 and article ID=0002 are mistakenly identified as one from the other. It is to be noted that an explanation has been given in a manner so as to specify an observed value containing an identifying error of articles; however, this explanation is based on the assumption that true positions of the articles have been known, and in an actual state, it is not sometimes understood from only the observed values as to whether or not an erroneous identification of articles has actually taken place.

Each time an observed value including identification information of an object existing in a room (one example of an observation space) to be observed and position information of the object is sequentially obtained, the article-state change determination unit 203 determines presence or absence of a state change as to whether or not the object inside the observation space is at least in a stationary state, based on the correspondence relationship between the observed value including the identification information and position information of the object and object-state information corresponding to the latest estimated value relating to the existing state in the observation space of the object to be observed and the position of the object. More specifically, the article-state change determination unit 203 sequentially determines whether or not any change in the existing state of an object, that is, “an article is taken out”, or “an article is placed”, has occurred, from the observed value acquired by the observed value acquiring means 201 and the estimated value of the past article position kept in the article-position estimated value table 206, each time the article-state change determination unit 203 receives an observed value.

Operations of the article-state change determination unit 203 will be described later in detail by reference to a flow chart.

When the article-state change determination unit 203 determines that “a change in the existing state of an article is present”, the article-state change determination unit 203 adds the observation time of the observed value used for the determination and the result of the determination as to the existing state of the article to an article-state change information table 204 to be recorded therein.

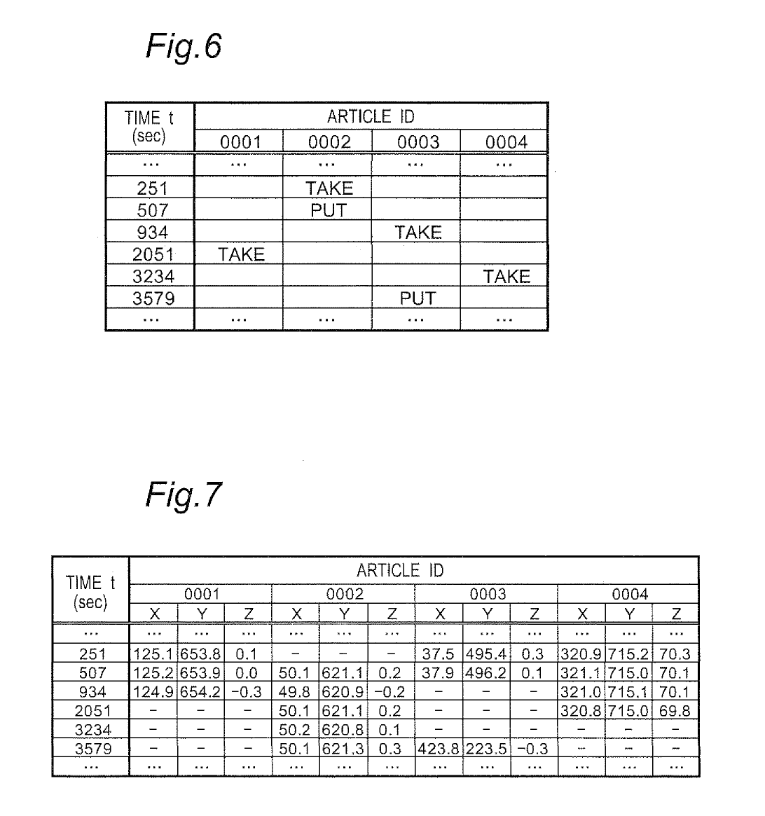

The article-state change information table 204 records article-state change information (information relating to any change in the existing state of an article, such as “an article is placed”, or “an article is taken out”) that has been determined by the article-state change determination unit 203, together with the observation time. FIG. 6 shows one example of recorded information.

In FIG. 6, the fact that an article is taken out is indicated by “TAKE”, and the fact that an article is placed is indicated by “PUT” respectively for each of article ID's. Spaced “frames” indicate that no change takes place in the existing state relating to the corresponding article.

When the object-state change determination unit 203 determines that any change has taken place in the existing state of an object, the batch estimation unit 205 estimates the identification information and the position information of the object, based on an observed value obtained during a predetermined period of time from the time at which the object-state change determination unit 203 has determined that there is the change in the existing state of the object and the existing state of the object determined by the object-state change determination unit 203. More specifically, based on determination result information from the article-state change determination unit 203, the batch estimation unit 205 receives observed values obtained in a fixed elapsed period of time from the time at which the article-state change determination unit 203 has determined that “a change in the existing state of an article is present” from the observed value accumulating table 202, and executes a batch estimation process, with a group of observed values over a plurality of periods of time being used as inputs.

Operations of the batch estimation unit 205 will be explained later.

In a case where the batch estimation unit 205 has determined that there is any contradiction between the result of any change in the existing state of the article determined by the article-state change determination unit 203 and the existing state of the article as the result of article position estimated by the batch estimation unit 205, the batch estimation unit 205 rewrites the article-state change information on the article-state change information table 204 based on the result of estimated article position by the batch estimation unit 205. The estimated position in the world coordinate system for each of the articles estimated by the batch estimation unit 205 is added to an article-position estimated value table 206 together with the time information to be recorded thereon. In this case, as the time information to be recorded, the observed time for the first observed value among the group of observed values used in the batch estimation is used.

The article-position estimated value table 206 records information of the estimated position for each of the articles estimated by the batch estimation unit 205. FIG. 7 shows an example of the recorded information. In the table of FIG. 7, portions (indicated by hyphen) without numeric values indicate that the corresponding article has been taken out by a person or the like, with the result that no estimated position of the article has been obtained.

When receiving a request from the article position display operating mouse 211 through the article position display unit 210 so as to output position information for a specific article at a certain point of time, the article position estimated value output unit 207 outputs the past position estimated value closest to the corresponding time among pieces of position information for each of the articles recorded on the article-position estimated value table 206. However, in a case where no position information relating to the specified article is present, that is, for example, in a state where the specified article has been taken out by a person or the like, information representing “under transportation” is outputted from the article position estimated value output unit 207 in place of outputting the position information of the specified article.

Supposing that estimated positions of articles are recorded as shown in an example of FIG. 7, when receiving a request from the article position display unit 210 by the article position estimated value output unit 207 so as to output the position of article ID=0001 at time 300 (sec), the article position estimated value output unit 207 outputs an estimated position (125.1, 653.8, 0.1) corresponding to the estimated position at time 251 (sec) that is the past time closest to time 300 (sec) to the article position display unit 210. When receiving a request from the article position display unit 210 by the article position estimated value output unit 207 so as to output the position of article ID=0002 at time 300 (sec), since article ID=0002 is taken out by a person or the like at time 251 (sec) that is the past time closest to time 300 (sec), with the result that no position relating to article ID=0002 can be estimated, the article position estimated value output unit 207 outputs information representing “under transportation by a person” to the article position display unit 210. The article position display unit 210 requests the article position estimated value output unit 207 so as to send position information of each of the articles specified by the user through the article position display operating mouse 211 or the like, and displays the estimated position of each of the articles thus received.

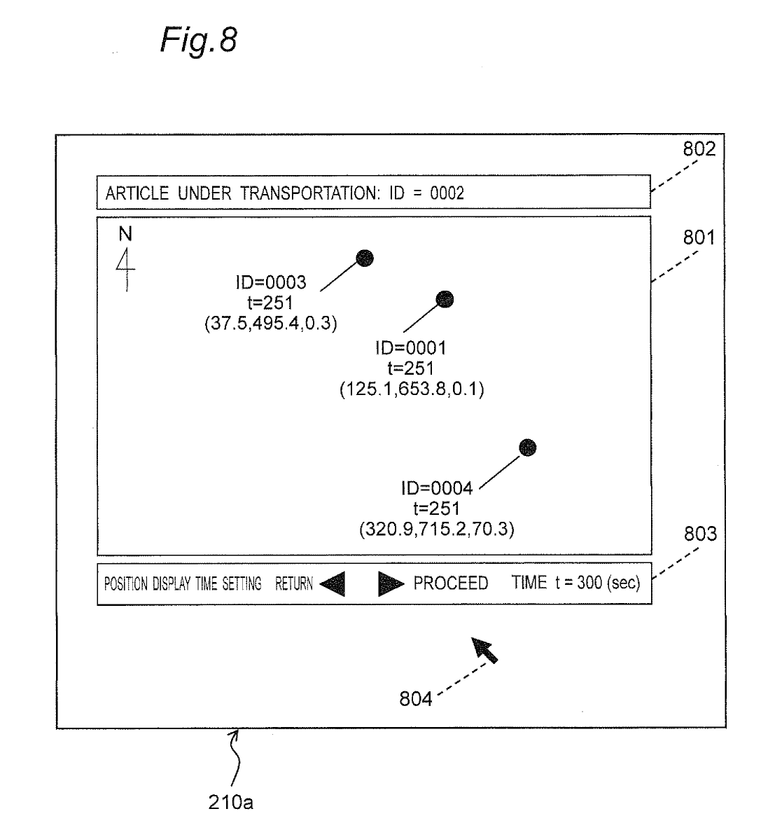

FIG. 8 shows a display example of a display screen 210a of the article position display unit 210. A rectangular region 801 shows a plane coordinate system when the floor surface 302 of the room 300 is viewed down from the ceiling 301, which corresponds to an XY plane of the world coordinates of the room 300. The upper left corner of the rectangular region 801 is the origin (X, Y)=(0, 0). The position of each of articles is indicated by a black circle “”, an article ID, time t at which the article is placed, and XYZ coordinates of the article position. For example, the article positions at time 300 (sec) are displayed based on estimated positions of the respective articles at time 251 (sec) of FIG. 7.

A rectangular region 802 represents an ID of an article that is being transported by a person or the like (an article whose position estimation is not available, that is, an article with no position information). The example of FIG. 8 indicates that the object with article ID=0002 is being transported by a person or the like, with the result that no position information is available.

In the rectangular region 803, the user sets time of an article position that the user wants to know. The user operates the article-position display operating mouse 211 to move a mouse pointer 804 inside the display screen 210a so that by clicking “a return button” or “a proceed button” of the rectangular region 803 to increase or decrease the value of time t displayed on the right end of the rectangular region 803, the time of the article position to be desirably known is specified.

Each time the user sets time of an article position to be desirably known by operating the article-position display operating mouse 211, the article position display unit 210 requests the article position estimated value output unit 207 to send position information of the article at the corresponding time, receives an article position estimated value from the article position estimated value output unit 207, and displays the position of each of the articles and the ID of an article that is being transported by a person or the like, respectively in the rectangular region 801 and the rectangular region 802.

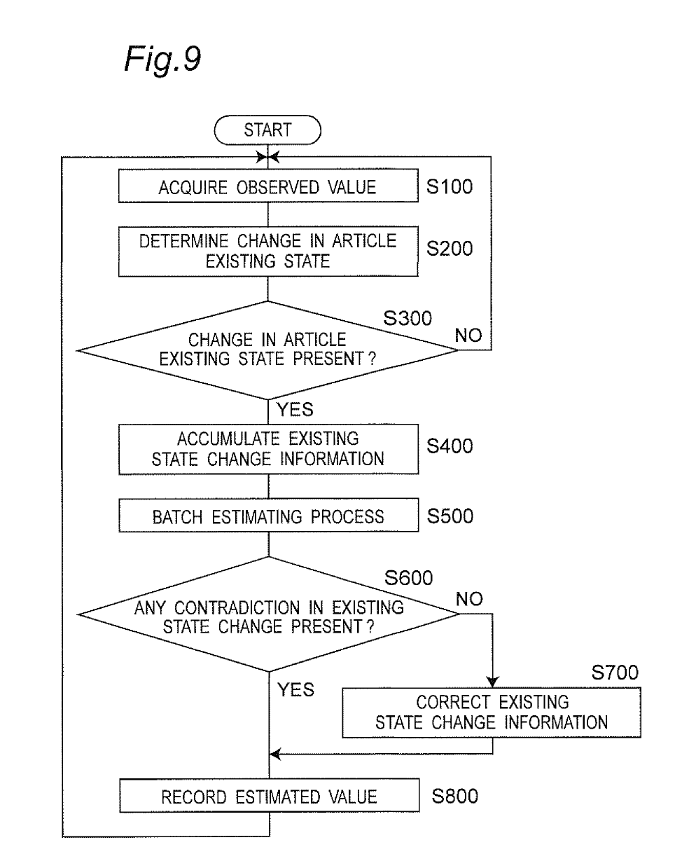

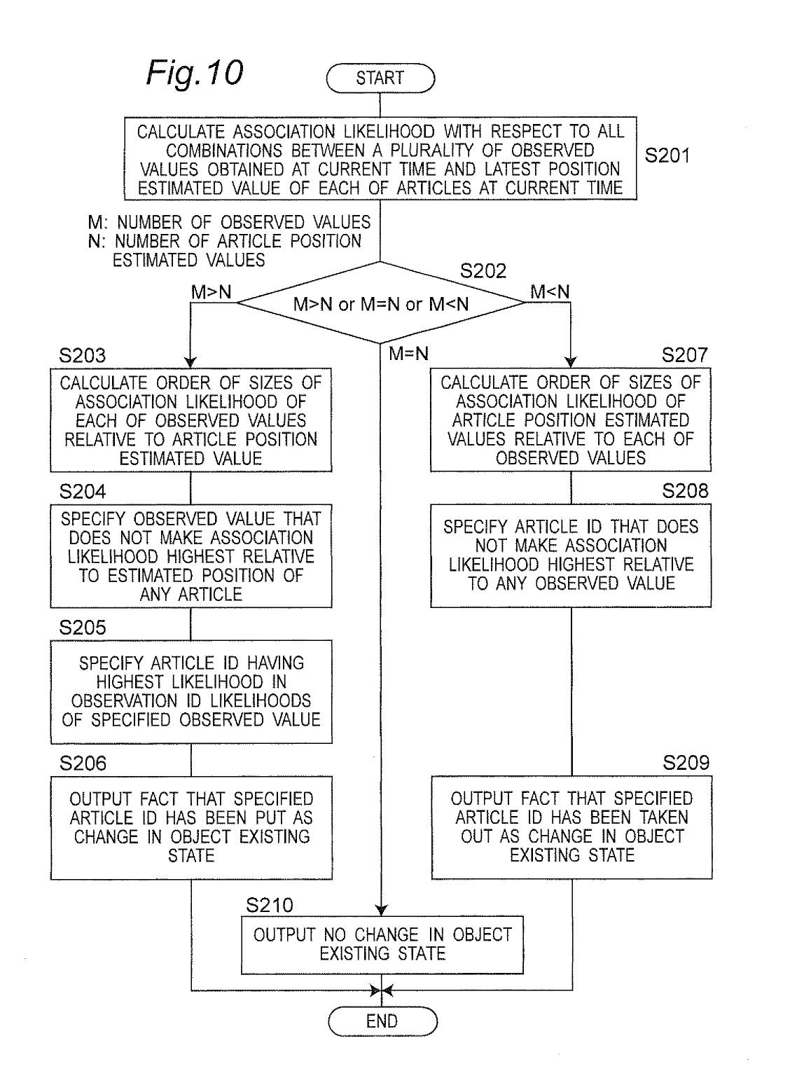

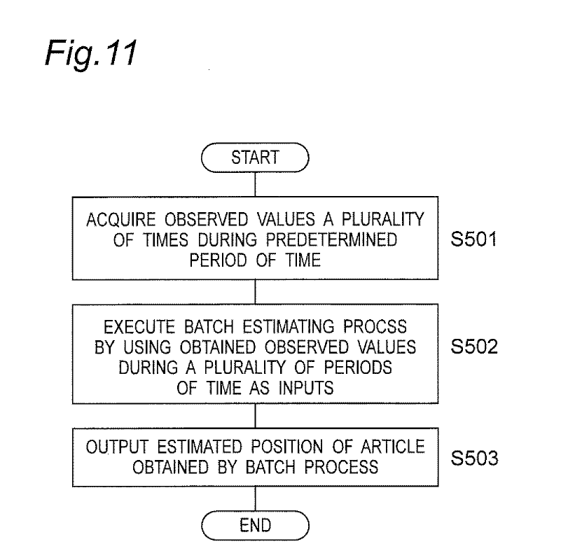

Referring to FIGS. 9 and 10, as well as a flow chart of FIG. 11, the following will describe operations of the object position estimation apparatus 200 in detail.

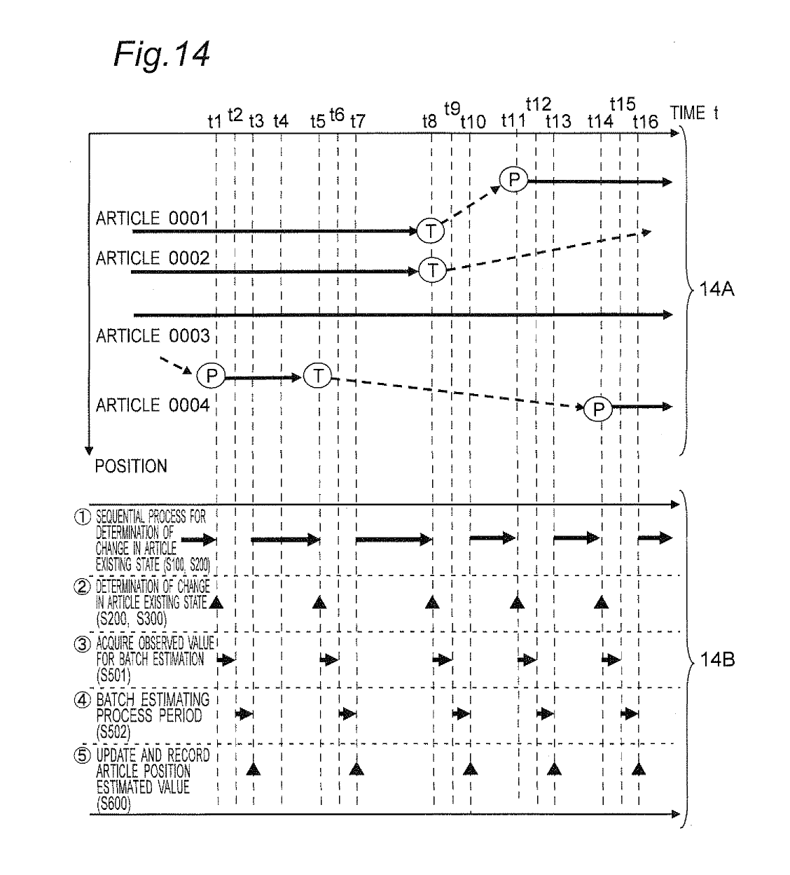

In the following explanation of the operations of the object position estimation apparatus 200, the explanation will be given on the assumption that a change in the existing state of each of articles occurs as shown in an upper half of chart 14A of a timing chart of FIG. 14. In the chart 14A that is a timing chart showing a change in the existing state of each of articles, the axis of ordinate indicates the position and the axis of abscissa indicates the time. The position is one-dimensionally indicated for convenience of explanation. The true positions of four articles from article ID=0001 to article ID=0004 are indicated by arrows of solid lines, and a state in which an article is being carried by, for example, a person is indicated by an arrow of a dotted line.

Since the article is stationary except that it is being carried by a person, the article position is represented by a straight line orthogonal to the position axis in chart 14A. On the other hand, although the article performs an optional motion while being carried by a person, since the position of the article while being carried is not a subject to be estimated, the motion of the article is represented by a straight line (broken line) in chart 14A for convenience of explanation.

In chart 14A, the time and position of each of articles having a change in the article existing state (the time and position at which an article is “taken out” or “placed”) is indicated by a white circle “O”, and in a case where the article is placed, “O” is displayed inside the white circle “O”, while in a case where the article is taken out, “T” is displayed inside the white circle “O”.

Chart 14A represents changes in the existing state of articles, in which article ID=0004 is placed at time t1, article ID=0004 is taken out at time t5, article ID=0001 and article ID=0002 are taken out at time t8, article ID=0001 is placed at time t11, and article ID=0004 is placed at time t14. The chart indicates that no change takes place in article ID=0003 during a period from time t1 to time t16.

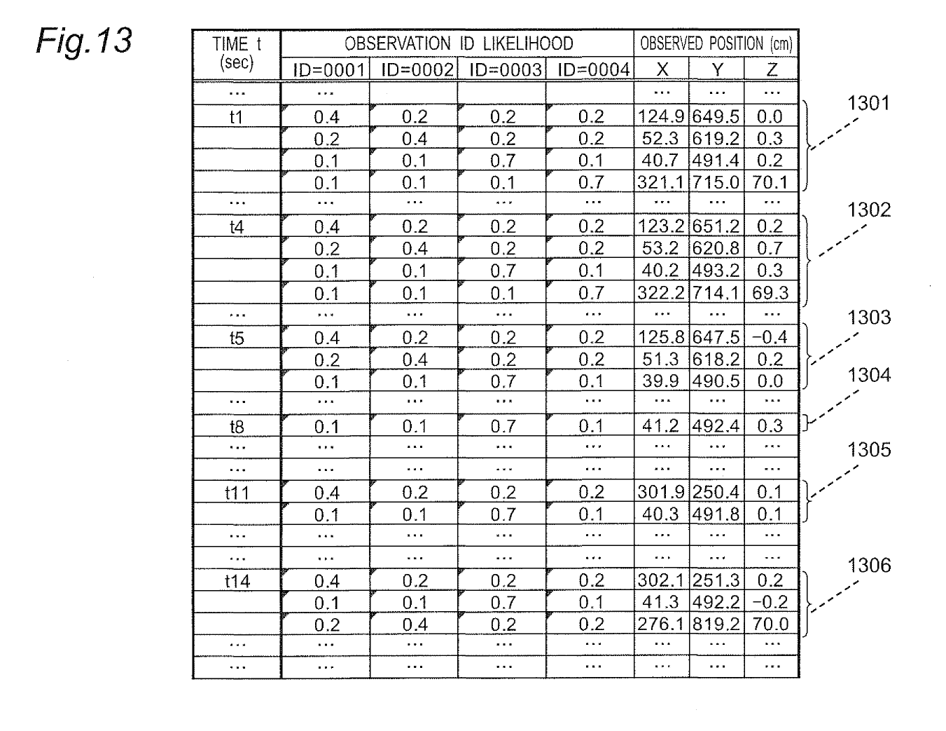

In response to the changes in the existing state of articles shown in FIG. 14, observed values of the articles at times t1, t4, t5, t8, t11, and t14 are supposed to be obtained as shown in FIG. 13.

FIG. 9 is a flow chart showing a flow of operations of the object position estimation apparatus 200. The flow of the operations are schematically explained as processes in which, when receiving an observed value of an article, a determination is made as to whether or not any change in the existing state of articles has occurred based on the observed value and the latest estimated position of the article, and only in a case where, there is any change in the existing state, a position estimation is newly carried out by a batch estimating process so that the estimated position is recorded.

The observed value acquiring process in step S100 in FIG. 9 corresponds to an operation that is executed by the observed value acquiring unit 201 in the object position estimation apparatus 200 of FIG. 2A. In step S100, the observed value acquiring unit 201 acquires observed values outputted from the article-image recognizing sensor 209 of FIGS. 2A and 2B, and by using the current time obtained from the time managing unit 208 as the observation time, the observation time and observed value are recorded in the observed value accumulating table 202, and also outputted to the article-state change determination unit 203.

Next, an article-state change determination process in step S200 is executed by the article-state change determination unit 203 in the object position estimation apparatus 200 of FIG. 2A.

Referring to a flow chart of FIG. 10, the following will describe an inner process of step S200.

In the flow chart of FIG. 10, processes from step S201 to step S202 are those processes carried out by the article-state change determination unit 203 as to whether or not any change in the existing state of an article has taken place on the basis whether or not a new article has been observed or whether the placed article has not been observed.

Processes from step S203 to step S206 are those processes carried out by the article-state change determination unit 203 as to which article has been placed when an article is newly placed.

Processes from step S207 to S209 are those processes carried out by the article-state change determination unit 203 as to which article has been taken out when any article is taken out.

Step S210 corresponds to a process to be carried out in the article-state change determination unit 203 when no change in the existing state of an article is found. In step S201, the article-state change determination unit 203 calculates an association likelihood defined by the following (formula 1), with respect to all the combinations between a plurality of observed values obtained from the observed value acquiring unit 201 at the current time and the latest article position estimated value for each of the articles at the current time, recorded on the article-position estimated value table 206. Supposing that the number of the article position estimated values is N, and that the number of observed values that have been obtained is M, M×N number of association likelihoods are calculated by the article-state change determination unit 203.

p(y|X,r=j)=pₚₒₛ(yₚₒₛ|X,r=j)·p_{ID}(y_{ID}|X,r=j) [Equation 1]

where

y=(y_{ID},yₚₒₛ) (Formula 1)

The association likelihood is a value representing certainty of correspondence between an actual article and an observed value and can be mathematically formulated on a basis of theory of probability. In the left side of (formula 1), supposing that the number of article position estimated values is N, X represents a combined vector of article-position estimated values corresponding to the N-number, and y represents a vector of observed values in which observed ID likelihood y_{ID} and observed position likelihood yₚₒₛ are combined with each other. In this case, r represents a state variable representing which article is observed by y among N-number of articles, and in the case of r=j, this means that the article having an article ID of j has been observed. The left side of (formula 1) represents a probability with a condition in which, when a certain article position estimated value vector X is given and the article is observed, the observed value vector y can be obtained.

In the right side of (formula 1), pₚₒₛ(yₚₒₛ|X, r=j) represents a likelihood relative to the position of a j-numbered article of yₚₒₛ corresponding to the observed position of the observed value vector y. Moreover, the right side of (formula 1), p_{ID}|y_{ID}|X, r=j) is a term corresponding to the observed ID likelihood of the observed values. In the present first embodiment, as represented by the right side of (formula 1), the likelihood of the article position and the observed ID likelihood are formulated by using models that are mutually independent.

$$\begin{matrix} [ Equation 2 ] & \\ {p}_{pos} ( {y}_{pos} \vert X , r = j ) = \frac{1}{{( 2 π )}^{d / 2} {\vert \sum \vert}^{1 / 2}} exp ( - \frac{1}{2} ( {y}_{pos} - {x}_{j} ) {\sum }^{- 1} {( {y}_{pos} - {x}_{j} )}^{T} ) \\ \\ \begin{matrix}X = ( {x}_{1} , {x}_{2} , … , {x}_{N} ) & \\ {x}_{j} = ( {x}_{j , x} , {x}_{j , y} , {x}_{j , z} ) & \sum = ( \begin{matrix}{σ}_{x}^{2} & {σ}_{xy} & {σ}_{xz} \\ {σ}_{yx} & {σ}_{y}^{2} & {σ}_{yz} \\ {σ}_{zx} & {σ}_{zy} & {σ}_{z}^{2}\end{matrix} ) \\ {y}_{pos} = ( {y}_{x} , {y}_{y} , {y}_{z} ) & \end{matrix} & ( Formula 2 )\end{matrix}$$

(Formula 2) is a formula for use in defining pₚₒₛ(yₚₒₛ|X, r=j) of (formula 1). In the present first embodiment, the positional error characteristic of the article-image recognizing sensor 209 is supposed to be approximated by using a three-dimensional normal distribution. In (formula 2), d represents the number of dimensions of positional coordinates, and d=3 holds. Moreover, x represents three-dimensional coordinate values of the estimated position of an article having an article ID of j, yₚₒₛ represents three-dimensional coordinate values of the observed value at the observed position. Here, Σ represents a 3×3 matrix that is a covariance matrix representing the positional error characteristic of the article-image recognizing sensor 209. In particular, in a case where no correlation exists among positional errors of the respective dimensions, a diagonal matrix is formed with diagonal components forming a variance of errors in the respective dimensions. With respect to this Σ, position measuring experiments of each article are preliminarily carried out by the article-image recognizing sensor 209 so as to obtain the corresponding value.

$$\begin{matrix}[ Equation 3 ] & \\ {p}_{ID} ( {y}_{ID} \vert X , r = j ) = \{ \begin{matrix}{C}_{j} & if {y}_{ID} = j \\ \frac{1 - {C}_{j}}{N - 1} & if {y}_{ID} \neq j\end{matrix} & ( Formula 3 )\end{matrix}$$

(Formula 3) is a formula for use in defining p_{ID}(y_{ID}|X, r=j) of (formula 1). In this case, Cⱼ is an identification rate relating to an article whose article ID is j of the article-image recognizing sensor 209. Moreover, N represents the number of articles serving as subjects to be observed. In the present first embodiment, it is supposed that the observation ID likelihood is formulated by (formula 3). In other words, it is supposed that upon observation of an article whose article ID is j, a likelihood in the observation ID likelihood relative to the article ID of j is represented by Cⱼ and that a likelihood relative to the article ID of not j is obtained by (1−Cⱼ)/(N−1). In this definition, upon observation of an article whose article ID is other than j, the probability of erroneously identifying the article as an article whose article ID is j is defined as the same probability with respect to all the articles other than the article whose article ID is j. As described in the explanation relating to the article-image recognizing sensor 209, the value of Cⱼ is preliminarily obtained by carrying out identifying experiments of articles by the article-image recognizing sensor 209.

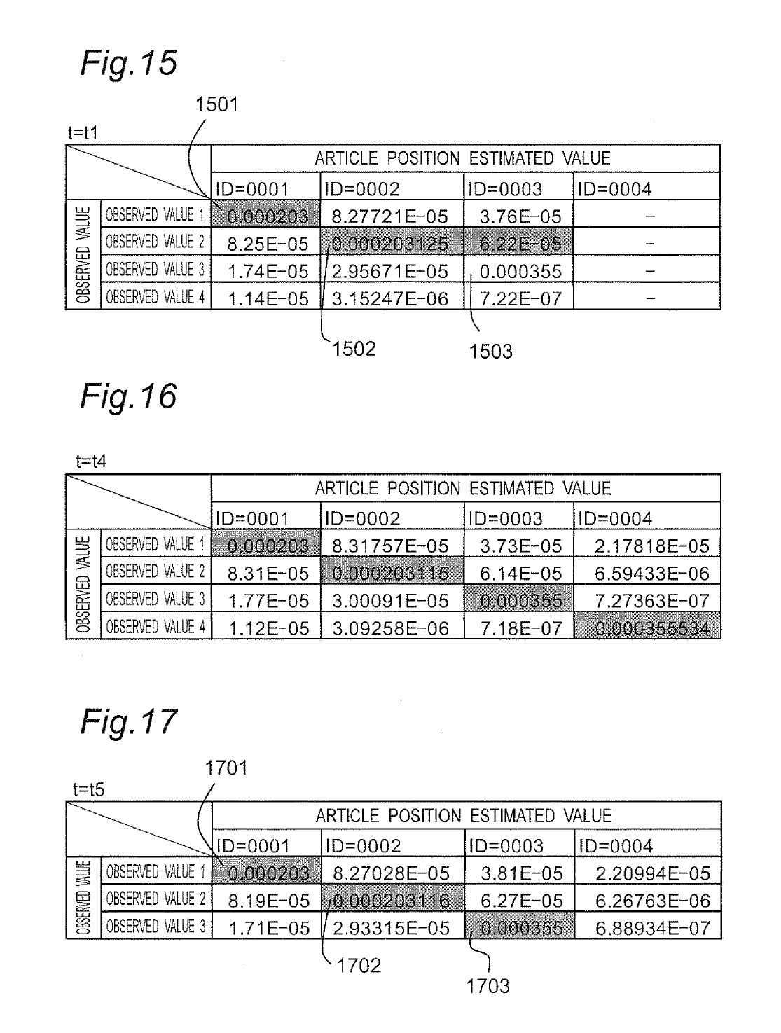

FIGS. 15, 16, and 17 show examples of the association likelihood calculated in step S201.

FIG. 15 shows the results of calculations at time t1 at which article ID=0004 is placed. More specifically, supposing that the current time is time t1, calculations are carried out on combinations between an observed value 1301 at time t1 of FIG. 13 and an article position estimated value at time t0 that is the latest time relative to time t1 of FIG. 19. Additionally, although time t0 of FIG. 19 is not described in the chart 14A of FIG. 14, time t0 is a point of time prior to time t1 at which the article position estimated value, obtained by a batch estimation process when article ID=0004 is taken out, is recorded.

FIG. 16 shows the results of calculations at time t4 having no change in the existing state of an article. The calculations are carried out on combinations between an observed value 1302 at time t4 of FIG. 13 and an article position estimated value at time t1 of FIG. 19 prior to time t4.

FIG. 17 shows the results of calculations at time t5 at which article ID=0004 is taken out. The calculations are carried out on combinations between an observed value 1303 at time t5 of FIG. 13 and an article position estimated value at time t1 of FIG. 19 prior to time t5.

In step S202, the number of observed values M and the number of article position estimated values N used for calculating the likelihood in step S201 are compared with each other in the article-state change determination unit 203 so that a condition branching process is carried out.

The contents of the condition branching process are explained as the following three cases:

1) In a case where M>N, the sequence proceeds to step S203 (in a case where an article is newly placed),

2) in a case where M=N, the sequence proceeds to step S210 (in a case where there is no change in the existing state of articles), and

3) in a case where M<N, the sequence proceeds to step S207 (in a case where an article is taken out). FIGS. 15, 16, and 17 respectively show the results of calculations on the association likelihood at time t1, time t4, and time t5 of FIG. 14. In step S202, at time t1, N=3 and M=4 hold, which corresponds to the above-mentioned branched condition 1), at time t4, N=4 and M=4 hold, which corresponds to the branched condition 2), and at time t5, N=4 and M=3 hold, which corresponds to the branched condition 3).

The following will describe processes from step S203 to step S206 corresponding to processes in which an object is newly placed. A specific example of the processes is given based on the results of calculations on the likelihood at time t1 shown in FIG. 15.

The following will first briefly describe a flow of processes from step S203 to step S206: in step S203 and step S204, the article-state change determination unit 203 determines which observed value does not correspond to any of the articles that are currently placed. Next, in step S205, the article-state change determination unit 203 determines which article the observed value that does not correspond to any of the articles is derived from, and in step S206, the article-state change determination unit 203 outputs the resulting value as the determination results in the article existing state.

In step S203, with the article ID of the article position estimated value being fixed based on the likelihood calculated in step S201, the order of the sizes of the association likelihoods is determined by the article-state change determination unit 203. For example, the article-state change determination unit 203 compares the sizes of the likelihood in the column direction of the table of the calculation results of likelihoods of FIG. 15, and determines the order.

Next, in step S204, after the article-state change determination unit 203 determines the order of association likelihoods in step S203, an observed value whose association likelihood is not maximized relative to any of the article ID's is specified.

In the table of the calculation results of association likelihoods of FIG. 15, portions 1501, 1502, and 1503 with gray backgrounds are association likelihoods that are maximized as the results of determination of the order in step S203. In this case, an observed value 1 has the highest association likelihood relative to the position estimated value of article ID=0001 (see column 1501 of FIG. 15). An observed value 2 has the highest association likelihood relative to the position estimated value of article ID=0002 (see column 1502 of FIG. 15). An observed value 3 has the highest association likelihood relative to the position estimated value of article ID=0003 (see column 1503 of FIG. 15). However, an observed value 4 has no highest association likelihood relative to any articles. Therefore, the article-state change determination unit 203 determines that the observed value 4 corresponds to an observed value to be specified in step S204.

Next, in step S205, the article-state change determination unit 203 specifies an article ID having the highest likelihood among the observation ID likelihoods of the observed values, specified in step S204.

Based on the results of calculations of the association likelihood in FIG. 15, the observed value 4 is specified in step S204. The observed value 4 is the fourth observed value from the top of the observed values of 1301 in FIG. 13, and the article ID having the highest observation ID likelihood is 0004. Therefore, in step S205, the article ID is specified as 0004 by the article-state change determination unit 203.

Next, in step S206, an article having the article ID specified in step S205 is determined by the article-state change determination unit 203 as “an article that has been newly placed”, and the article-state change determination unit 203 outputs a result of determination in the change of the article-existing state indicating that “the corresponding article ID has been placed” as the output of step S200.

Based on the calculation results of association likelihood of FIG. 15, as the results of the sequence of processes from step S203 to step S206, the article-state change determination unit 203 outputs the fact that an article whose article ID is 0004 has been “PUT” (placed).

The following will describe a process of step S210 corresponding to a state where no change occurs in the article-existing state. In this step, the fact that “no change occurs in the article-existing state” is outputted as an output from the article-state change determination unit 203. Ata point of time t4 in FIG. 14, it is determined that no change is present in the existing state of articles.

The following will describe processes from step S207 to step S209 corresponding to a case where an article is taken out. A specific example of the processes is given based on the results of calculations on the likelihood at time t5 shown in FIG. 17.

The following will first briefly describe a flow of processes from step S207 to step S209: in step S207 and step S208, the article-state change determination unit 203 determines which article among the articles does not correspond to the observed value obtained. Next, in step S209, the article-state change determination unit 203 outputs the determination results in the article existing state indicating that an article ID has been taken out, which is determined in step S208.

In step S207, with the observed value being fixed to one value relative to the association likelihood calculated in step S201, the order of the sizes of the association likelihoods is determined by the article-state change determination unit 203. For example, the article-state change determination unit 203 compares the sizes of the likelihood in the row direction of the table of the calculation results of association likelihoods of FIG. 17, and determines the order.

Next, in step S208, after determining the order of association likelihoods in step S207 by the article-state change determination unit 203, an article ID whose association likelihood is not maximized relative to any of the observed values is specified.

When explained by reference to the example of FIG. 17, portions 1701, 1702, 1703 with gray backgrounds are association likelihoods that are maximized as the results of determination of the order in step S207. In this case, the position estimated value of article ID=0001 has the highest association likelihood relative to the observed value 1 (see column of 1701 of FIG. 17). The position estimated value of article ID=0002 has the highest association likelihood relative the observed value 2 (see column of 1702 of FIG. 17). The position estimated value of article ID=0003 has the highest association likelihood relative to the observed value 3 (see column of 1703 in FIG. 17). However, the position estimated value of article ID=0004 has no highest association likelihood relative to any observed values. Therefore, the article-state change determination unit 203 determines that the article ID of 0004 forms an article ID to be specified in step S208.

Next, in step S209, the article-state change determination unit 203 determines that an article having the article ID specified in step S208 corresponds to “an article that has been taken out”, and the article-state change determination unit 203 outputs a result of determination in the change of the article-existing state indicating that “the corresponding article ID has been taken out” as the output of step S200.

Based on the calculation results of association likelihood of FIG. 17, as the results of the sequence of processes from step S207 to step S209, the article-state change determination unit 203 outputs the fact that an article whose article ID is 0004 has been “TAKEN OUT” (taken out).

The above is the explanation of the article-state change determination process in step S200. Returning again to the flow chart of FIG. 9, the following will continuously describe the processing steps of the object position estimation apparatus 200.

In step S300 following step S200, in a case where the article-state change determination unit 203 has determined that there is any change in the article-existing state in the process of step S200, the sequence is branched to step S400, while in a case where the article-state change determination unit 203 has determined that there is not any change in the article-existing state in the article-state change determination unit 203, the sequence returns to step S100.

In step S400, in response to the output of the determination result in the article-existing state change from the article-state change determination unit 203 in step S200, the change in the article-existing state is recorded in the article-state change information table 204 by the article-state change determination unit 203. The contents to be recorded are the same as those explained in the article-state change information table 204.

Step S500 is a batch estimation process of an article position that is carried out by the batch estimation unit 205 when there is any change in the article-existing state.

Referring to a flow chart of FIG. 11, a flow of processes in step S500 will be explained.

In step S501 in FIG. 11, first, the batch estimation unit 205 gives an instruction to the observed value acquiring unit 201 so that, during a predetermined period of time from a point of time acquired when the article-state change determination unit 203 has determined that there is any change in the article-existing state, an observed value is acquired by the observed value acquiring unit 201, and recorded on the observed value accumulating table 202.

Additionally, in this case, with respect to a period of time (or a number of acquiring times) in which observed values are acquired, it is fixed within a range so as to preliminarily obtain desired positional precision (an upper limit of positional deviations) through experiments, and is also fixed so that a period of time up to completion of the position-estimating process by the batch processing is within a range that causes no problems in the frequency of state changes in an article to be measured.

For example, in the object position estimating device 200 in the first embodiment, with respect to an article serving as a subject to be position-estimated, after the article has been brought into a stationary state, with a period of time in which an observed value is obtained by the observed value acquiring unit 201 from the article-image recognizing sensor 209 being changed (or with the number of times in which observed values are obtained being changed), a batch estimating process is carried out by the batch estimation unit 205 so that a minimum acquiring period of time for observed values which is capable of providing required positional precision (for example, several seconds, or a minimum number of acquiring times of observed values) is set to a constant period of time (or number of times).

In step S502, the observed value used when determined that there was a change in the article state in step S200 is acquired from the observed value accumulating table 202 together with the observed values acquired a plurality of times for the constant period of time in step S501 are acquired so that the batch estimation unit 205 carries out an article position estimating process by the batch estimation.

As the method for the batch estimation, an estimation algorithm capable of dealing with the correspondence relationship between a plurality of articles and a plurality of observed values on a probability basis is used. As the estimation algorithm for use in the batch estimation unit 205, for example, a method disclosed in (Non-Patent Document 1: “Localization and Identification of Multiple Objects with Heterogeneous Sensor Data by EM Algorithm”, SICE-ICASE international Joint Conference (SICE-ICCAS) 2006), written by Hirofumi Kanazaki, Takehisa Yairi, Junichi Shibata, Yohei Shirasaka and Kazuo Machida) is proposed. In the first embodiment, since the observed value obtained by the article-image recognizing sensor 209 contains likelihood (observation ID likelihood) relating to identification of an article, the EM algorithm with which the framework of data association disclosed in the above-mentioned Non-Patent Document is combined can be applied thereto.

The following will additionally describe the outline of the batch estimating process using the algorithm disclosed in Non-Patent Document 1.

In the following additional explanation, X represents a combined vector of an N-number of article-position estimated values, and x_{j,pos} represents a j-numbered article estimated position. Here, Y represents a combined vector of an M-number of observed values that form an input for the batch estimation, and yᵢ represents a i-numbered observed value. The yᵢ forms a vector of observed values in which an observed ID likelihood y_{ID} and an observed position yₚₒₛ are combined with each other. Moreover, rⱼ represents a state variable indicating which article the observed value yⱼ is derived from (for example, in the case of rᵢ=j, the observed value yⱼ represents a state in which the j-numbered article is observed). Additionally, the definitions of X, Y, and r are equivalent to definitions of the estimated value of an article position, the observed value of an article position (an article ID likelihood and an observed value) and the state variable indicating which article the observed value is derived from, in the present embodiment; therefore, it is noted that a specific batch estimation algorithm to be explained below is applicable to the batch estimating system for the batch estimation unit 205 of the present embodiment.

The batch estimation algorithm to be explained below is referred to as a MAP estimation method (maximum a posteriori estimation method), and by obtaining a value of X (X=X*) that maximizes a probability represented by p(X|Y), X, that is, an article position is estimated.

$$\begin{matrix}[ Equation 4 ] & \\ {X}^{*} = {arg max}_{X} p ( X \vert Y ) & ( Formula 4 )\end{matrix}$$

What is meant by X* obtained by the MAP estimation of this (formula 4) is that when receiving observation data Y, supposing that p(X|Y) is maximized when X=X*, X* represents a value of X that has the highest probability. In other words, X* is supposed to give a position having the highest probability as the article position.

Based on Bayes theorem, p(X|Y) is transformed into the following formula.

$$\begin{matrix}[ Equation 5 ] & \\ \begin{matrix}p ( X \vert Y ) ∝ p ( Y \vert X ) \cdot p ( X ) \\ = [ {\sum }_{R} p ( Y , R \vert X ) ] \cdot p ( X ) \\ = [ {\sum }_{R} {\prod }_{i = 1}^{M} p ( {y}_{i} , {r}_{i} j \vert X ) ] \cdot p ( X ) \\ = [ {\prod }_{i = 1}^{M} {\prod }_{j = 1}^{N} p ( {y}_{i} , {r}_{i} = j \vert X ) ] \cdot p ( X )\end{matrix} & ( Formula 5 )\end{matrix}$$

After transformed as indicated by (formula 5), the MAP estimation is carried out by an EM algorithm. The EM algorithm is an algorithm in which by iterating two calculation steps, that is, E-Step (estimating step) and M-Step (maximizing step), the MAP estimation is executed. It is supposed that X^{(t)} corresponds to an estimate value of an article position X obtained by the t-numbered calculation of the repetitive calculations of the EM algorithm. The following steps show the EM algorithm for use in the MAP estimation of p(X|Y), which is transformed as shown in (formula 5).

$$\begin{matrix} E \text{-} Step \text{:} \\ \begin{matrix}Q ( X \vert {X}^{( t )} ) = {\sum }_{i = 1}^{M} {\sum }_{j = 1}^{N} P ( {r}_{i} = j \vert {y}_{i} , {X}^{( t )} ) log p \\ ( {y}_{i} , {r}_{i} = j \vert X ) \\ = {\sum }_{i = 1}^{M} {\sum }_{j = 1}^{N} {α}_{ij}^{( t )} \{ log p ( {y}_{i} \vert X , {r}_{i} = j ) + log p ( {r}_{i} = j \vert X ) \}\end{matrix} & ( Formula 6 ) \\ \begin{matrix}{α}_{ij}^{( t )} = P ( {r}_{i} = j \vert {y}_{i} , {X}^{( t )} ) \\ = \frac{p ( {y}_{i} \vert {r}_{i} = j , {X}^{( t )} ) \cdot P ( {r}_{i} = j \vert {X}^{( t )} )}{{\sum }_{{r}_{t} = 1}^{N} p ( {y}_{i} \vert {r}_{i} , {X}^{( t )} ) \cdot P ( {r}_{i} \vert {X}^{( t )} )}\end{matrix} & \\ {\sum }_{j = 1}^{N} {α}_{ij}^{( t )} = 1 \\ M \text{-} Step \text{:} \\ {X}^{( t + 1 )} = {arg max}_{X} Q ( X \vert {X}^{( t )} ) & \end{matrix}$$

Since from the definition of (formula 1) of the present embodiment, p(yᵢ|X, rᵢ=j)=P_{ID} (y_{i,ID}|X, rᵢ=j)·pₚₒₛ (y_{i,pos}|rⱼ=j) holds, by substituting this for (formula 6), the following formula is obtained:

$$\begin{matrix} [ Equation 7 ] & \\ E \text{-} Step \text{:} \\ Q ( X \vert {X}^{( t )} ) = {\sum }_{i = 1}^{M} {\sum }_{j = 1}^{N} {α}_{ij}^{( t )} \{ log {P}_{ID} + log {p}_{pos} \} - M log N & ( Formula 7 )\end{matrix}$$

In this transformation, since N-number of articles are observed in the same frequency, pₚₒₛ(r_{i,pos}|X)=1/N is set in (formula 6).

With respect to Q(X|X^{(t)} of (formula 7), in order to obtain X that maximizes M-Step of formula 6), that is Q(X|X^{(t)}), by solving the following formula, the (succeeding formula 8) is obtained:

$$\begin{matrix}[ Equation 8 ] & \\ \frac{\partial Q}{\partial {x}_{i , pos}} = 0 & \\ [ Equation 9 ] & \\ {x}_{j , pos}^{( t + 1 )} = \frac{{\sum }_{i = 1}^{M} {α}_{ij}^{( t )} {y}_{i , pos}}{{\sum }_{i = 1}^{M} {α}_{ij}^{( t )}} & ( Formula 8 )\end{matrix}$$

Moreover, with respect to α of (formula 6), the following formula is obtained.

$$\begin{matrix}[ Equation 10 ] & \\ {α}_{ij}^{( t + 1 )} = \frac{p ( {y}_{i} \vert {r}_{i} = j , {X}^{( t + 1 )} )}{{\sum }_{{r}_{i} = 1}^{N} p ( {y}_{i} \vert {r}_{i} , {X}^{( t + 1 )} )} & ( Formula 9 )\end{matrix}$$

In this transformation also, pₚₒₛ(y_{i,pos}|X)=1/N is set. Additionally, the right side of (formula 9) is obtained by substituting X=X^{(t+1)} for (formula 1), (formula 2), and (formula 3) in the present embodiment. (Formula 8) and (formula 9) are updating formulas for use in obtaining X^{(t+1)} from X and by carrying out repetitive calculations base on these updating formulas, X* can be obtained.

The initial value of an article estimated position in these iterative calculations is given as X⁽⁰⁾.

The following will describe how to give the initial value of the article position estimation, upon starting a batch estimating process in the above-mentioned step S502.

In a case where an article is newly placed, with respect to articles that have no change in the existing state, the latest article position estimated value recorded in the article-position estimated value table 206 is used by the batch estimation unit 205 as an initial value for the article position estimation. As the initial value of the estimated position in an article position estimating process relating to the article newly placed, the observed position of the observed value specified in step S204 is used by the batch estimation unit 205. In a case where an article is taken out, the batch estimation unit 205 deals with the articles other than the article taken out as having no change in the existing state.

In step S503, the estimated position of each of the articles, obtained in step S502, is outputted from the batch estimation unit 205 as the result of the batch estimation.

The above is the explanation of the batch estimation process of the article position carried out by the batch estimation unit 205 in step S500.

Returning again to the flow chart of FIG. 9, the following description is given.

In step S600 following step S500, the batch estimation unit 205 determines whether or not there is any contradiction between the existing state of each of the articles clarified by the estimation result of the batch estimation unit 205 in step S500 and the existing state of each of the articles determined by the article-state change determination unit 203 in step S200.

When the batch estimation unit 205 determines that there is any contradiction in step S600, in step S700, based on the estimation results from the batch estimation unit 205, the existing state of the articles inside the article-state change information table 204 is rewritten by the batch estimation unit 205.

The following will describe the reasons why the determining process in the batch estimation unit 205 in step S600 is required and why the rewriting process in the existing state of the articles inside the article-state change information table 204 by the batch estimation unit 205 in step S700 is required.

In step S205 in the process flow relating to the state in which an article is added in step S200, the article-state change determination unit 203 specifies that the article ID having the highest observation ID likelihood of observed values that does not correspond to any of the currently existing articles is an ID of the article that has been added. At this time, due to disturbances on the article observation, such as a temporary occlusion or fluctuations in illumination of the space to be observed, there is a possibility that the article-image recognizing sensor 209 might cause an erroneous identification of the article. In the case of the erroneous identification, the likelihood of an article ID that is not the ID of the article that has been actually added becomes higher, with the result that in step S200, the article-state change determination unit 203 might erroneously determine that an article having an erroneous article ID corresponds to the article that has been added, and in step S400, the article-state change determination unit 203 might record in the article-state change information table 204 that an article having an erroneous article ID has been “PUT”.

In this case, however, in step S500, since the batch estimation unit 205 carries out an estimating process of the article position based on a plurality of observed values within a predetermined period of time, the influences from the erroneous identification of the article due to a temporary disturbance can be suppressed so that the batch estimation unit 205 makes it possible to clarify that, finally, the article with a right article ID has been added.

Therefore, in step S600, the batch estimation unit 205 compares the existing state of the right article obtained by the batch estimating process of step S500 and the existing state of each of the articles recorded in the article-state change information table 204, and in a case where the batch estimation unit 205 determines that the two states are different from each other, the batch estimation unit 205 rewrites the contents of the article-state change information table 204 based on the results of the batch estimating process in step S500, in step S700.

With respect to a specific example of a process in which, upon occurrence of a contradiction in step S600 as described earlier, the rewriting process is carried out in step S700, and the explanation thereof will be given later, in detail.

When the batch estimation unit 205 determines that there is no contradiction in step S600, or after, in step S700 the batch estimation unit 205 has rewritten the contents of the article-state change information table 204 based on the results of the batch estimating process of step S500, the sequence proceeds to step S800.

In step S800, the article position estimated value for each of the articles, estimated by the batch estimation unit 205 in step S500, is recorded in the article-position estimated value table 206 by the batch estimation unit 205. With respect to the position estimated value to be recorded, the same value as explained in the article-position estimated value table 206 may be used. After the process in step S800, a sequence of object position estimating process operations are completed, or as shown in the Figure, the sequence returns to step S100.

With respect to the main processing steps of operation flows (FIG. 9, FIG. 10, and FIG. 11) of the object position estimation apparatus 200 that have been explained above, the following will briefly describe in the form of timing charts, as to what timing each of the processes is carried out in response to a change in the existing state of an article.

A chart 14B corresponding to the lower half of FIG. 14 is a chart showing timings in which main processing steps of the processing flow are operated in the object position estimation apparatus 200 shown in FIGS. 9, 10, and 11. The chart 14B that is a timing chart of the operation sequence of the object position estimation apparatus 200 commonly possesses the time axis (axis of abscissas) with a chart 14A indicating the elapsed time in a state change of each of the articles. In the chart 14B, “▴” indicates timing in which a processing step to be carried out in a short period of time is operated, and an arrow in a solid line represents a period of time in which the short-period step is repeatedly carried out, or timing in which a processing step that continues for a constant period of time is operated.

During periods of time (t<t1, t3<t<t5, t7<t<t8, t10<t<t11, t13<t<t14, and t16<t) in which no state change in the articles occurs, observation value acquiring processes and determining processes of the state change in the articles from step S100 to step S300 are repeatedly carried out.

In the timing at which any state change in the article state (change in the article existing state) (t=t1, t5, t8, t11, and t14) occurs, after passing through step S400, the article-position estimating process of the batch estimation unit 205 is carried out in step S500. In step S500, a plurality of observed values are acquired (step S501), and after completion of the batch estimating process (step S502), in step S800, after recording the article position estimated value obtained in the batch estimation in the article-position estimated value table 206, the sequence returns to step S100, and the repetitive processes of step S100 to step S300 are resumed.

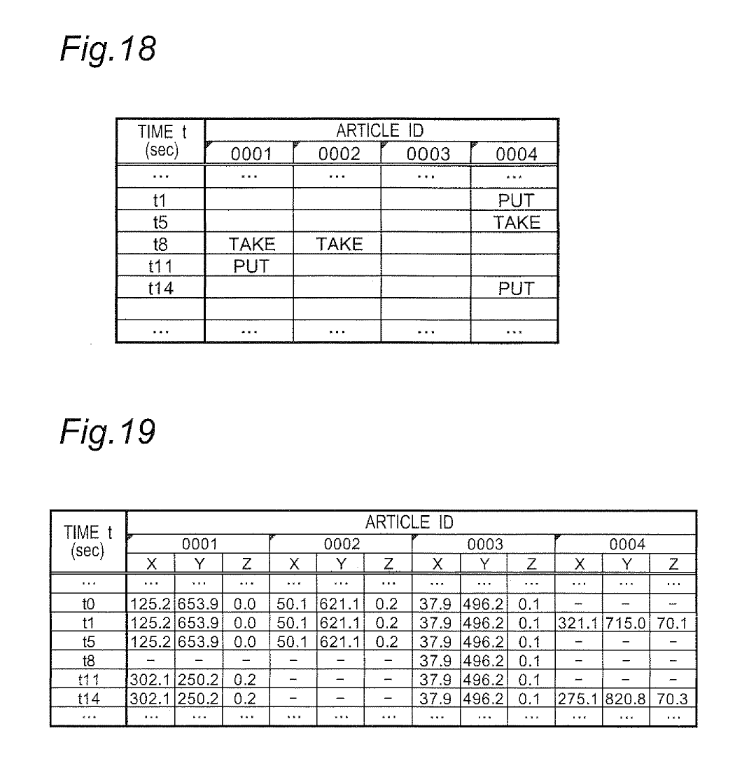

Additionally, FIG. 18 represents the contents of the article-state change information table 204 at a point of time t=t16, and FIG. 19 represents the contents of the article-position estimated value table 206 also at a point of time t=t16.

In the timing chart of FIG. 14, at t=t8, there is a state where two articles of article ID=0001 and article ID=0002 are simultaneously taken out. In this case also, through the processing flow from step S201 to step S209 in the flow chart of FIG. 10, it is determined that the two articles have been taken out in the following manner.

With respect to one observed value (1304 in FIG. 13) obtained at t=t8 and the latest article position estimated value at that time (article position estimated value at t=t5 of FIG. 19), calculations of the association likelihood are carried out by the article-state change determination unit 203 in step S201, and in step S202, since the number of observed values M=1 holds relative to the number of article position estimated values N=3, the article-state change determination unit 203 determines that articles have been taken out.

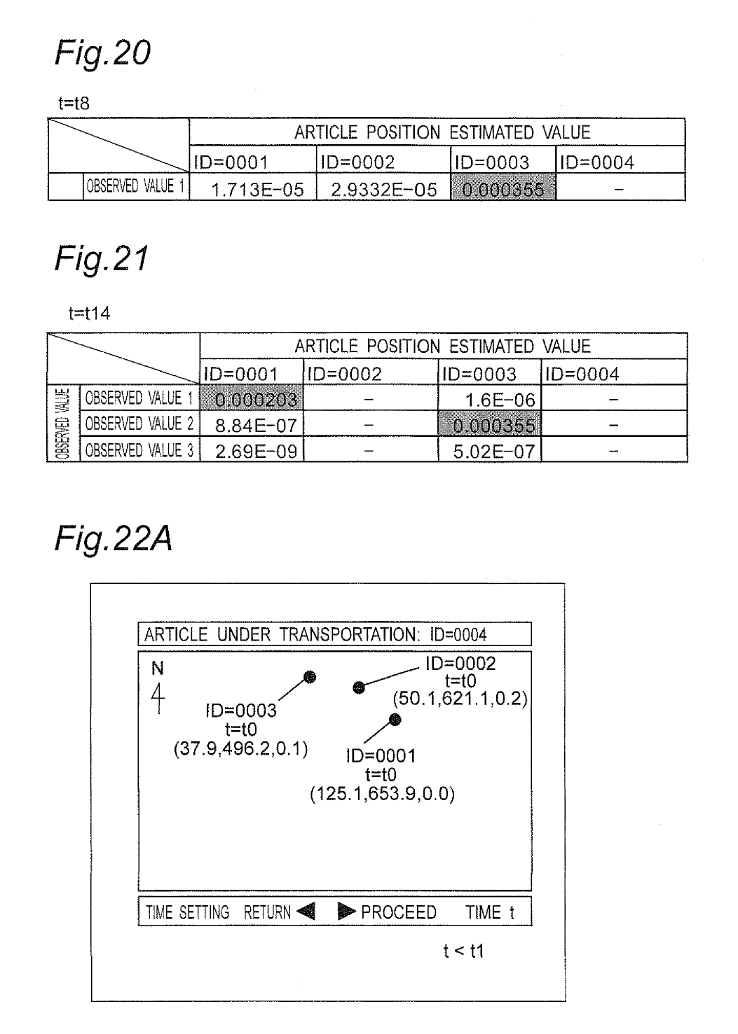

FIG. 20 shows the results of calculations of association likelihood at time t8. Based on the association likelihood, since it is found that in the processes of step S207 and step S204, each of article ID=0001 and article ID=0002 does not have a maximum value in likelihood relative to the single observed value (1304 in FIG. 13) thus obtained, the article-state change determination unit 203 determines that these two articles have been taken out.

In the timing chart of FIG. 14, during a period of t10<t<t11, there is a state where three articles of article ID=0001, article ID=0002, and article ID=0004 have been taken out, and at t=t11, there occurs a state where one of them is placed (article ID=0001 is placed in FIG. 14). At t=t11, with respect to the determination of the article-state change determination unit 203 as to which article among article ID=0001, article ID=0002, and article ID=0004 has been placed, the article-state change determination unit 203 gives the following solution by a flow of processes from step S201 to step S206 in the flow chart of FIG. 10.

First, with respect to two observed values (1305 in FIG. 13) obtained at t=t11 and the latest article position estimated value at that time (an article position estimated value at t=t8 in FIG. 19), in step S201, calculations of the association likelihood are carried out by the article-state change determination unit 203, and in step S202, since the number of observed values M=2 holds relative to the number of article position estimated value N=1, the article-state change determination unit 203 determines that an article has been placed.

In the processes of step S203 and step S204, the article-state change determination unit 203 specifies an observed value (the first one from the top of 1305 of FIG. 13) that does not form a maximum value in the association likelihood with respect to each of the position estimated value of article ID=0002 and the position estimated value of article ID=0003.

In step S205, since, among the observed ID likelihoods of the specified observed value, the article ID that has a maximum value is 0001, the article-state change determination unit 203 specifies that the corresponding article ID is 0001 so that the article-state change determination unit 203 determines that not article ID=0004, but article ID=0001, is placed.

Based on a specific example, the following will additionally explain the processes of step S600 and step S700 in the flow of FIG. 9.

In the timing chart of FIG. 14, at t t14, article ID=0004 is placed. At this time (t=t14), observed values of articles are given as 1306 of FIG. 13. The third observed value from the top of observed values 1306 corresponds to article ID=0004 that is placed at t=t14; however, due to an erroneous identification of articles of the article-image recognizing sensor 209, not ID=0004, but ID=0002 has a maximum value in the observation ID likelihood.

With respect to observed values 1306 and the latest article-position estimated value (an article position estimated value at t=t11 of FIG. 19) at that time, calculations of the association likelihood are carried out in the article-state change determination unit 203 in step S201, and in step S202, since the number of observed values M=3 holds relative to the number of article position estimated values N=2, the article-state change determination unit 203 determines that an article has been placed.

FIG. 21 shows the results of calculations of the association likelihood at t=t14. In the processes of step S203 and step S204, based on the results of calculations of the likelihood of FIG. 21, the article-state change determination unit 203 specifies an observed value (the third one from the top of 1306 of FIG. 13) that does not form a maximum value in the association likelihood with respect to each of the position estimated value of article ID=0001 and the position estimated value of article ID=0003. In step S205, since, among the observed ID likelihoods of the specified observed value, the article ID that has a maximum value is 0002, as described above, the article-state change determination unit 203 specifies that the corresponding article ID is 0002 so that it is determined in step S200 of FIG. 9 by the article-state change determination unit 203 that article ID=0002 is placed.

Moreover, in step S400, the article-state change determination unit 203 records in the article-state change information table 204 that article ID 0002 has been “PUT”.

Next, in the batch estimating process in step S500, since the estimating process of the article position is carried out by using observed values obtained over a plurality of times as inputs, the batch estimation unit 205 is allowed to execute the estimation by using the observed values together with observed values without an identification error obtained after observed values 1306 temporarily containing an identification error of articles; thus, the influences of observed values 1306 that erroneously identify article ID=0004 as article ID=0002 are suppressed so that as a result, the estimation results indicating that article ID=0001, article ID=0003, and article ID=0004 are present can be obtained by the batch estimation unit 205.

Therefore, in step S600, the batch estimation unit 205 collates the article-state change information recorded in the article-state change information table 204 so that the batch estimation unit 205 determines that the information that article ID=0002 has been “PUT” contradicts the batch estimation result. For this reason, in step S700, the batch estimation unit 205 deletes the information indicating that article ID=0002 has been “PUT” recorded in the article-state change information table 204, and the batch estimation unit 205 rewrites the information with information that article ID=0004 has been “PUT” in the article-state change information table 204.

Therefore, even when the article-state change determination unit 203 has made an erroneous determination on the change in the article state due to a temporarily erroneous article identification information of the article-image recognizing sensor 209, the article state information to be recorded in the article-state change information table 204 is revised correctly by the article position estimating process in the batch estimation unit 205 using a plurality of observed values.

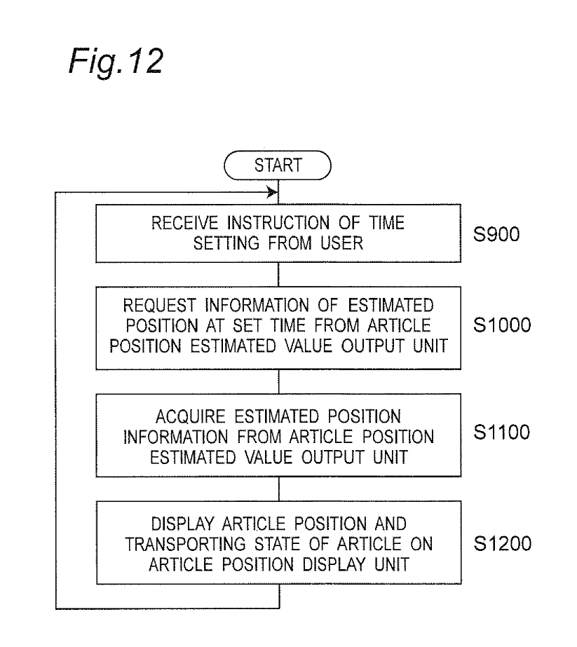

Lastly, referring to a flow chart in FIG. 12, the following will describe operations of the article position display unit 210. In this case, the processing flow shown in FIG. 9 and the processing flow shown in FIG. 12 are supposed to be operated mutually independently (asynchronously).

In step S900 of FIG. 12, the user inputs a point of time of the position of an article to be desirably known on the article position display unit 210 by using the article position display-operating mouse 211. More specifically, the user manipulates a mouse pointer 804 on the screen (FIG. 8) of the article position display unit 210, and clicks “a return button” or “a proceed button” of a rectangular region 803, or keeps clicking the button so that time t on the right end of the rectangular region 803 is changed, and the time t that is displayed in synchronized timing with a release from a clicked state by the user is set on the article position display unit 210 as the time of the position of an article to be desirably known by the user.

Next in step S1000, the article position display unit 210 requests the article position estimated value output unit 207 to send information of the article position at the time set in step S900.

Next, in step S1100, the article position estimated value output unit 207 acquires information of an article position estimated value at the requested time from the article-position estimated value table 206 and outputs the value to the article position display unit 210.

In step S1200, the estimated value of the article position received by the article position display unit 210, and information as to which article is being under transportation are displayed in the rectangular region 801 and the rectangular region 802 of the display screen 210a of the article position display unit 210.

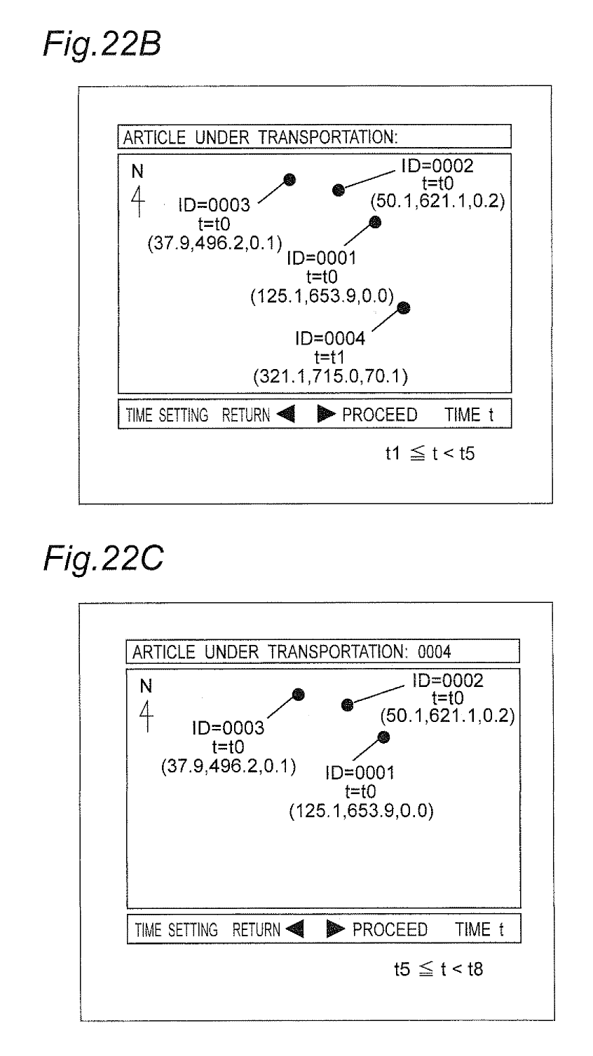

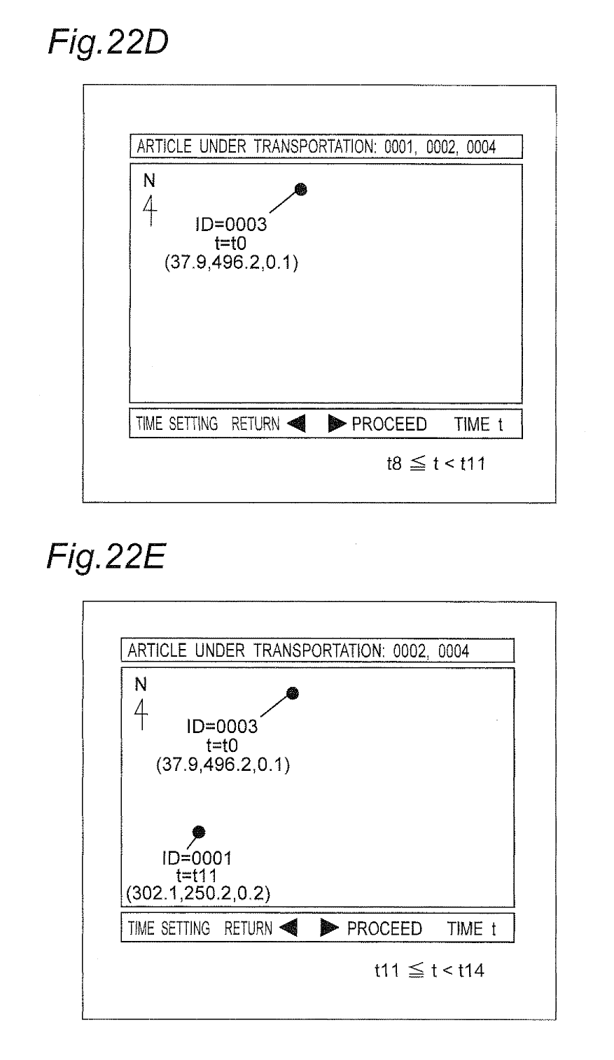

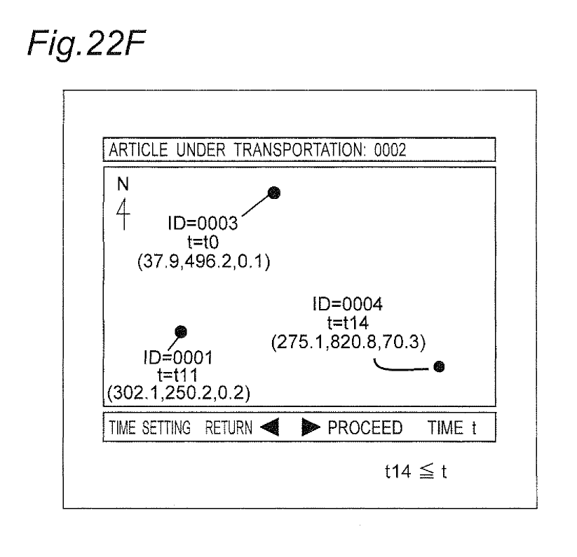

As shown in chart 14A of FIG. 14, when a state change occurs in the article state, depending on the value of time t specified by the user, the display of the estimated position of the article is changed in a manner as shown in FIGS. 22A to 22F. FIG. 22A shows a screen that represents a displayed estimated position of the article at time t<t1 (for example, t=t0). FIG. 22B shows a screen that represents a displayed estimated position of the article during a period of time t1≦t<t5. FIG. 22C shows a screen that represents a displayed estimated position of the article during a period of time t5≦t<t8. FIG. 22D shows a screen that represents a displayed estimated position of the article during a period of time t8≦t<t11. FIG. 22E shows a screen that represents a displayed estimate position of the article during a period of time t11≦t<t14. FIG. 22F shows a screen that represents a displayed estimated position of the article at time t14≦t.

In accordance with the structure of the first embodiment, a degree of certainty of correspondence relationship between each of a plurality of observed values obtained from a plurality of articles and each of a plurality of the latest article states to be recorded in the article position estimated value table 206 is calculated as the association likelihood by the article-state change determination unit 203 so that the article-state change determination unit 203 can determine which article has been placed or which article has been taken out. With this arrangement, presence or absence of a change in the existing state of an article can be detected, and only in a case where there is a change in the existing state of articles, the position of the article is estimated with high precision by the batch estimation unit 205, while in a case where there is no change in the existing state of articles, the estimated result of the article position with high precision, obtained by the batch estimation and recorded in the article position estimated value table 206, can be outputted as the estimated result of the article position.

In other words, in accordance with the object position estimation apparatus 200 and an object position estimation method carried out by the object position estimation apparatus 200, as well as the object position estimation program that forms the object position estimation apparatus 200 as a program, it is possible to provide a remarkable effect in that, upon observation of a plurality of semi-stationary articles (for example, such articles as to move and stop repeatedly), after a position of each article has been determined with high precision by using a batch estimating process in synchronized timing with a change in the article state from a moving state to a stationary state, during a stationary state of the article, the position information with high precision obtained by the batch estimation can be outputted as estimated information.

Moreover in accordance with the object position estimation apparatus 200 and the object position estimation method carried out by the object position estimation apparatus 200, as well as the object position estimation program that forms the object position estimation apparatus 200 as a program, it is also possible to provide an effect in that, the article-state change determination unit 203 determines a state change from a stationary state to a moving state of an article to be observed, or a state change from a moving state to a stationary state thereof, so that, with respect to all the articles, a stationary state of each article or a moving state thereof can be confirmed at an optional point of time during the observation.

The present invention is not intended to be limited by the above-mentioned embodiments, and may be carried out in various other aspects.

For example, in the first embodiment, the estimated result of an article position is displayed on the article position display unit 210; however, as the application mode of the estimated position of the article, an input to another device that calls for knowing the position of the article may also be used, and the scope of the present invention is not limited by this mode.

Moreover, with respect to the object, not limited to the above-mentioned articles, for example, persons or animals, such as pet animals may be used. In short, the object that forms a subject in the present invention refers to an object capable of being transported by a person.

In the above-mentioned embodiment, each of the object-state change determination means 101, 203, the batch estimation means 102, 205, the object state information storage means 103, 204, 206, and the like, or optional portions thereof may include software. Therefore, a computer program that has steps forming control operations of the respective embodiments of the present specification may be prepared, and this may be readably stored in a recording medium such as a storage device (a hard disk or the like); thus, the computer program may be read into a temporary storage device (a semiconductor memory, or the like) of a computer, and the program is executed by a CPU so that the above-mentioned functions or respective steps can be executed.

By properly combining the arbitrary embodiments of the aforementioned various embodiments, the effects possessed by the embodiments can be produced.

### INDUSTRIAL APPLICABILITY

The object position estimation apparatus, the object position estimation method, and the object position estimation program in accordance with the present invention can be utilized for a device used for estimating positions of a plurality of objects (for example, a plurality of articles) that exist in a space to be observed, and might be transported at an arbitrary timing. For example, these can be applied to a system for managing article positions in a home, or a life assistant robot that autonomously transports an article that is called for by the user.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An object position estimation apparatus comprising:
an object-state change determination unit that, each time an observed value including identification information of an object existing in an observation space to be observed and position information of the object is sequentially obtained, determines presence or absence of a state change as to whether or not the object inside the observation space is at least in a stationary state, based on a correspondence relationship between the observed value including the identification information and the position information of the object and object-state information corresponding to a latest estimated value relating to an existing state in the observation space of the object to be observed and a position of the object; and
a batch estimation unit that, when the object-state change determination unit determines that there is a change in the existing state of the object, estimates the identification information and the position information of the object, based on an observed value obtained during a predetermined period of time from time at which the object-state change determination unit has determined that there is the change in the existing state of the object and the existing state of the object determined by the object-state change determination unit.

2. An object position estimation apparatus comprising:
an object-state change determination unit that, each time an observed value including identification information of each of a plurality of objects existing in an observation space to be observed and position information of the object is sequentially obtained, determines presence or absence of a state change as to whether or not each of the objects inside the observation space is at least in a stationary state, based on a correspondence relationship between the observed value including the identification information and the position information of each of the objects and object-state information corresponding to a latest estimated value relating to an existing state in the observation space of the object to be observed and a position of the object; and
a batch estimation unit that, when the object-state change determination unit determines that there is a change in the existing state of the object, estimates the identification information and the position information of the object, based on an observed value obtained during a predetermined period of time from time at which the object-state change determination unit has determined that there is the change in the existing state of the object and the existing state of the object determined by the object-state change determination unit.

3. An object position estimation apparatus according to claim 1, wherein, when the object-state change determination unit determines that there is a change in the object to be observed from the stationary state to a moving state, and then during a period until determination that the moving state has been changed to the stationary state is made, the batch estimation unit neither carries out any estimating process on the identification information and the position information of the object, nor outputs the estimated value.

4. An object position estimation apparatus according to claim 2, wherein, when the object-state change determination unit determines that there is a change in the object to be observed from the stationary state to a moving state, and then during a period until determination that the moving state has been changed to the stationary state is made, the batch estimation unit neither carries out any estimating process on the identification information and the position information of the object, nor outputs the estimated value.

5. The object position estimation apparatus according to claim 1, wherein, when the object-state change determination unit determines that there is a change in the object to be observed from a moving state to the stationary state, and then during a period until determination that the stationary state has been changed to the moving state is made, the batch estimation unit carries out an estimating process only once on the identification information and the position information of the object when determined that there is a change in the object into the stationary state, and then outputs the estimated value obtained by the estimating process as object state information of the object.

6. The object position estimation apparatus according to claim 2, wherein, when the object-state change determination unit determines that there is a change in the object to be observed from a moving state to the stationary state, and then during a period until determination that the stationary state has been changed to the moving state is made, the batch estimation unit carries out an estimating process only once on the identification information and the position information of the object when determined that there is a change in the object into the stationary state, and then outputs the estimated value obtained by the estimating process as object state information of the object.

7. An object position estimation method comprising:
each time an observed value including identification information of each of a plurality of objects existing in an observation space to be observed and position information of the object is sequentially obtained, determining presence or absence of a state change as to whether or not each of the objects inside the observation space is at least in a stationary state, based on a correspondence relationship between the observed value including the identification information and the position information of each of the objects and object-state information corresponding to a latest estimated value relating to an existing state in the observation space of the object to be observed and a position of the object, by using an object-state change determination unit; and
when the object-state change determination unit determines that there is a change in the existing state of the object, estimating the identification information and the position information of the object by using a batch estimation unit, based on an observed value obtained during a predetermined period of time from time at which the object-state change determination unit determines that there is the change in the existing state of the object and the existing state of the object determined by the object-state change determination unit.

8. An object position estimation program allowing a computer to execute an object-state change determining means by which, each time an observed value including identification information of each of a plurality of objects existing in an observation space to be observed and position information of the object is sequentially obtained, presence or absence of a state change as to whether or not each of the objects inside the observation space is at least in a stationary state is determined, based on a correspondence relationship between the observed value including the identification information and the position information of each of the objects and object-state information corresponding to a latest estimated value relating to an existing state in the observation space of the object to be observed and a position of the object; and
a batch estimation means by which, when the object-state change determination means determines that there is a change in the existing state of the object, the identification information and the position information of the object are estimated, based on an observed value obtained during a predetermined period of time from time at which the object-state change determination means has determined that there is the change in the existing state of the object and the existing state of the object determined by the object-state change determination means.
